(19) United States
(12) Patent Application Publication
(10) Pub. No.: US 2002/0049778 A1
(43) Pub. Date: Apr. 25, 2002

(54) System and method of information outsourcing

(76) Inventors: Peter W. Bell, Weston, MA (US); James E. Pownell, Natick, MA (US); William D. Miller, Colorado Springs, CO (US); Bruce A. Gordon, Maynard, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/821,703

(22) Filed: Mar. 29, 2001

Related U.S. Application Data
(63) Continuation of application No. 09/539,751, filed on Mar. 31, 2000.

(51) Int. Cl. G06F 7/00

(52) U.S. Cl. 707/200

(57) ABSTRACT

A method and apparatus for providing information outsourcing, including a storage node located remotely from an information outsourcing enterprise. The enterprise communicatively couples to the storage node to transfer information between the enterprise and the storage node in real-time to enable primary storage, static and dynamic mirroring, backup and disaster recovery of enterprise information. The system of the invention provides an enterprise user interface for enabling the enterprise to monitor its storage usage. The enterprise interface also enables the enterprise to expand or contract the storage space reserved by the enterprise at the storage node The system of the invention packages outsourcing services into service level agreements. Multiple storage nodes can be communicatively connected to enable the system to transfer information between them.

### FIELD OF THE INVENTION

The present invention relates generally to providing enterprises with storage outsourcing and related services. More particularly, according to one embodiment, the invention provides a method and apparatus for outsourcing information storage and for providing service level agreements for managing backup and primary storage.

### BACKGROUND OF THE INVENTION

Traditionally, information storage has been performed local to the computers that create, gather and process such information. The accessibility of stored information has been divided into primary on-line and secondary off-line storage. Local storage has enabled owners of information to maintain physical possession of the stored information within the confines of the information generating enterprise. Physical possession of the stored information has been thought to afford some measure of protection from theft, damage or destruction. Additionally, local storage has yielded significantly greater access performance by taking advantage of high speed, but range limited connections, such as with the SCSI and IEEE488 device interfaces, connecting the computers that process information with the storage devices that store information.

However, as computers and networks have become more advanced, enterprise dependence on computers, and the amount of information processed by enterprises, has also increased. Such information has become increasingly more network accessible both from within the enterprise, and from outside the enterprise. This trend has increased enterprise dependence on fast, reliable, on-line access to their expanding volume of stored data. Enterprise survival increasingly depends upon the protection and management of the data itself. Such an increase in storage volume and management complexity has brought with it a need for larger and more skilled professional data management support.

For example, electronic commerce based enterprises cannot function without on-line access to a substantial inventory of stored data. Such enterprises must have continuity of access during periods of scheduled maintenance and cannot tolerate unscheduled down-time. Also, enterprises may need to share access among multiple parts of the enterprise and among multiple computers, which may be distributed outside of one enterprise location.

Redundant storage of, and access to, stored information may be necessary for achieving minimum reliability and continuity of access, required for the enterprise to serve its customers. Separate and multiple versioned “snapshots” of stored information may be required to support software testing and analysis, or system disaster recovery. Such transient but continuous access demands for the stored data, and need for storage reliability, can necessitate the requisition and management of more hardware than can be consistently and efficiently utilized by the enterprise on a long term basis.

Regardless of the kinds of dependencies an enterprise may have upon its inventory of stored information, the size and complexity of the inventory will likely expand over time, apart from any economic growth realized by the enterprise. Any enterprise growth will further exacerbate the situation. Such inventory expansion may be physically, financially or organizationally constrained based upon circumstances surrounding the enterprise, and can cause a restriction to the growth and scalability of the entire enterprise. In essence, an enterprise can become a victim of its own success without the ability to scale or properly manage its information storage activities.

For many enterprises, information storage is fast becoming a mission critical activity that requires specialized and sophisticated, technological, logistical and organizational planning. In many circumstances, stored information has become too valuable for an enterprise to assume risks associated with the locality of its storage. In some circumstances, such as for a small electronic commerce startup enterprise, information storage may have become too large, complex and valuable an activity for an enterprise to perform by itself, if such an effort distracts an enterprise from other mission critical activities that its survival depends upon.

Accordingly, an object of the invention is to provide data outsourcing services to enterprises.

Another object of the invention is to provide primary, backup and disaster recovery data storage for enterprises.

### SUMMARY OF THE INVENTION

To address the disadvantages of methods and systems of information storage and management currently existing in the prior art, the invention provides a method and system for information storage and management outsourcing.

According to one embodiment, the invention enables a plurality of enterprises to transfer and store information to a remote information storage node managed by a storage provider. The information storage provider manages one or more storage nodes. A further aspect of the invention enables the enterprises to have on-line read and write access to the remotely stored information. In another aspect, a snapshot copy of enterprise information can be stored remotely for the purpose of backup and recovery. Optionally, such a backup copy can be performed in real-time utilizing a high bandwidth optical communication channel.

In another aspect, the enterprises can, on demand, request to reserve remote storage space or to update the amount of reserved remote storage space. Furthering this aspect, the enterprises can query the storage provider as to the actual cost of reserving a particular amount of remote storage space. In a further aspect, the enterprises can transiently expand its use of remote storage beyond the amount of reserved remote storage space, without explicitly requesting to update the amount of reserved remote storage space. Furthering this aspect, the enterprises can monitor the amount of remote storage actually utilized, separate from the amount of remote storage reserved.

According to another embodiment, enterprise sites can be operatively coupled to the remote storage node via a communications network, such as the Internet. Enterprise requests to reserve or update an amount of reserved remote storage, or enterprise monitoring of remote storage utilization or querying for cost estimates to reserve remote storage, can be communicated via this communications network.

In a further embodiment, the invention provides for service level agreements between the enterprises and the remote storage provider. The service level agreements that specify, at least in part, a guaranteed availability of access to and reliability of information stored by the remote storage provider. Optionally, the service level agreements specify, at least in part, a guaranteed frequency of snapshot copying of enterprise information stored at the storage node(s).

In another embodiment, the invention provides remote primary storage of enterprise information in a manner that is substantially transparent to application programs executing at an enterprise site. Furthermore, the invention can provide primary storage and all other remote information storage services at a distance of at least about one hundred feet from an enterprise site. Optionally, the invention can mirror selected enterprise information to generate a remote dynamic copy of the selected information at the remote storage node. The remote dynamic copy can be updated in substantially real time.

In another embodiment, the storage node can be located sufficiently remote from an enterprise site to provide an increased likelihood of the storage node surviving destruction of the enterprise site. Optionally, the storage node can be located to reduce risks to the integrity of information stored at the storage node posed by the geographic location of the enterprise site.

In another aspect, the invention provides each enterprise site with multiple access points to the storage node. Multiple access points enhance the reliability and bandwidth of access to the remotely stored information.

In another aspect, the invention provides an enterprise user interface to enable enterprises to monitor selected operational parameters relating to use of storage space at the storage node. Operational parameters can include the cost of storage space that has been previously utilized, or that is available to be utilized, by an enterprise. Furthermore, the enterprise user interface can be used to purchase available storage or to contract with the storage provider for a particular service level agreement.

The invention also provides a system user interface for the storage provider to monitor operational parameters associated with providing information outsourcing to the enterprise sites.

In an alternative embodiment, multiple storage nodes may be communicatively connected. Information outsourcing may be provided by a storage node that is not the most proximate storage node to an enterprise site. An enterprise site can be communicatively coupled to a second less proximate storage node by being communicatively coupled to a first more proximate storage node that is communicatively coupled to the second storage node by way of the communications connection between the first and the second storage nodes. Furthermore, the invention enables the two different enterprise sites, each communicatively coupled to a different storage node, to transfer information between each other by way of the communications connection between the two different storage nodes. Each separate enterprise site may be associated with the same enterprise, or with different enterprises. Alternatively, selected enterprise information stored at one storage node can be mirrored at another storage node to create a dynamic copy of the selected information.

In another embodiment, information transferred from a enterprise site to an original storage node, is copied to a plurality of other enterprise sites that are communicatively coupled to the original storage node or communicatively coupled to any other storage node that is directly or indirectly coupled the original storage node.

### BRIEF DESCRIPTION OF THE DRAWINGS

The foregoing and other objects, features and advantages of the invention, as well as the invention itself, will be more fully understood from the following illustrative description, when read together with the accompanying drawings, in which:

FIG. 1 is a logical block diagram depicting an illustrative embodiment of the invention including a storage node, a global operation center, a regional operation center and communication connections to enterprise and customer sites;

FIG. 2 is a logical block diagram of a storage node constructed in accord with the illustrative embodiment of FIG. 1, and adapted for supporting a primary storage service level agreement;

FIG. 3 is a logical block diagram of a storage node, constructed in accord with the illustrative embodiment of FIG. 1, and adapted for supporting a mirrored storage service level agreement;

FIG. 4 is a logical block diagram of a storage node, constructed in accord with the illustrative embodiment of FIG. 1, and adapted for supporting a backup storage service level agreement;

FIG. 5 is a logical block diagram of a storage node, constructed in accord with the illustrative embodiment of FIG. 1, and adapted for supporting a network storage service level agreement;

FIG. 6 is a logical block diagram depicting the interoperation between a storage node, constructed in accord with the illustrative embodiment of FIG. 1, and four separate and remotely located enterprise sites with separate service level agreements;

FIG. 7 is a logical block diagram depicting multiple storage nodes, constructed in accord with the illustrative embodiment of FIG. 1, located within the same region, and in communication with a regional operations center (ROC);

FIG. 8 is a logical block diagram depicting multiple storage networks, constructed in accord with the illustrative embodiment of FIG. 1, located across multiple regions, and in communication with a global operations center (GOC);

FIG. 9 is a logical block diagram depicting a storage node, constructed in accord with the illustrative embodiment of FIG. 1, and residing with multiple enterprise sites within a co-hosting facility;

FIG. 10 is a logical block diagram depicting multiple enterprise sites, located across multiple regions, in communication with a global operations center (GOC) constructed in accord with the illustrative embodiment of FIG. 1;

FIG. 11 is a logical block diagram depicting a global operations center (GOC), a regional operations centers (ROC), and multiple storage nodes, all constructed in accord with the illustrative embodiment of FIG. 1, located within the same region, and interconnected with a variety of local and remote enterprise sites;

FIG. 12 is an illustrative diagram depicting regions containing multiple storage nodes;

FIG. 13 is a logical block diagram depicting a storage node and an enterprise site, the storage node and the enterprise site configured in a dual redundant fashion;

FIG. 14 is an example of one of a plurality of system user interface screens, which displays both a geographical map of the United States and a map of the private network with respect to its connections to storage nodes and their associated network switching equipment;

FIG. 15 depicts an expanded view of the private network map shown in FIG. 14; and

FIG. 16 is an example of one of a plurality of enterprise user interface screens, which displays availability, capacity and usage information in a table format as it applies to the “moses.com” user organization.

### DESCRIPTION OF THE ILLUSTRATIVE EMBODIMENT

As briefly described above, the illustrative embodiment of the invention provides methods and apparatus for outsourcing information storage and for providing service level agreements for managing primary, backup, mirrored and network storage.

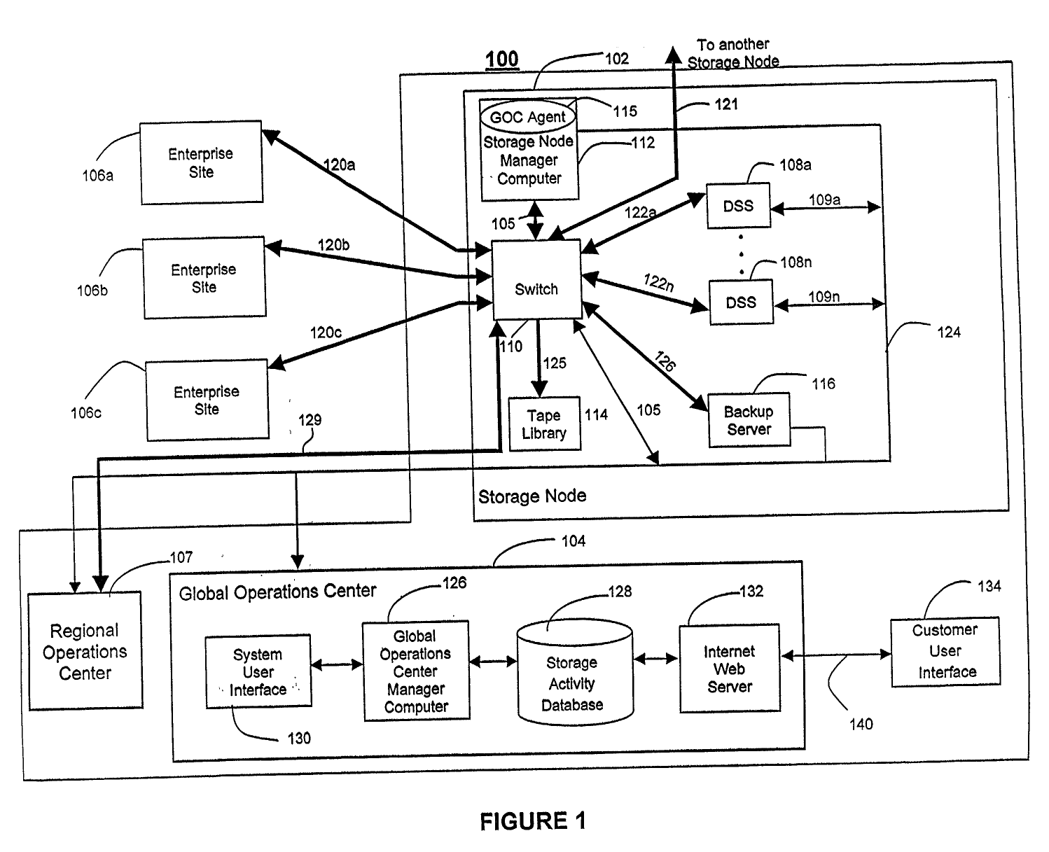

FIG. 1 is a conceptual block diagram of a storage system 100 according to an illustrative embodiment of the invention. The storage system 100 includes a storage node 102, a global operations center 104 and a regional operating center 107. A storage provider, through the storage system 100, provides information storage for the enterprise sites 106a-106c. Illustratively, only one storage node 102 and three enterprise sites 106a-106c are depicted. However, as will become apparent below, the illustrative storage system 100 can comprise a plurality of geographically disbursed storage nodes, which each service a plurality of enterprise sites. Additionally, the enterprise sites 106a-106c can reside at one or different geographic locations and can all be associated with one single enterprise, or can be each associated with different enterprises.

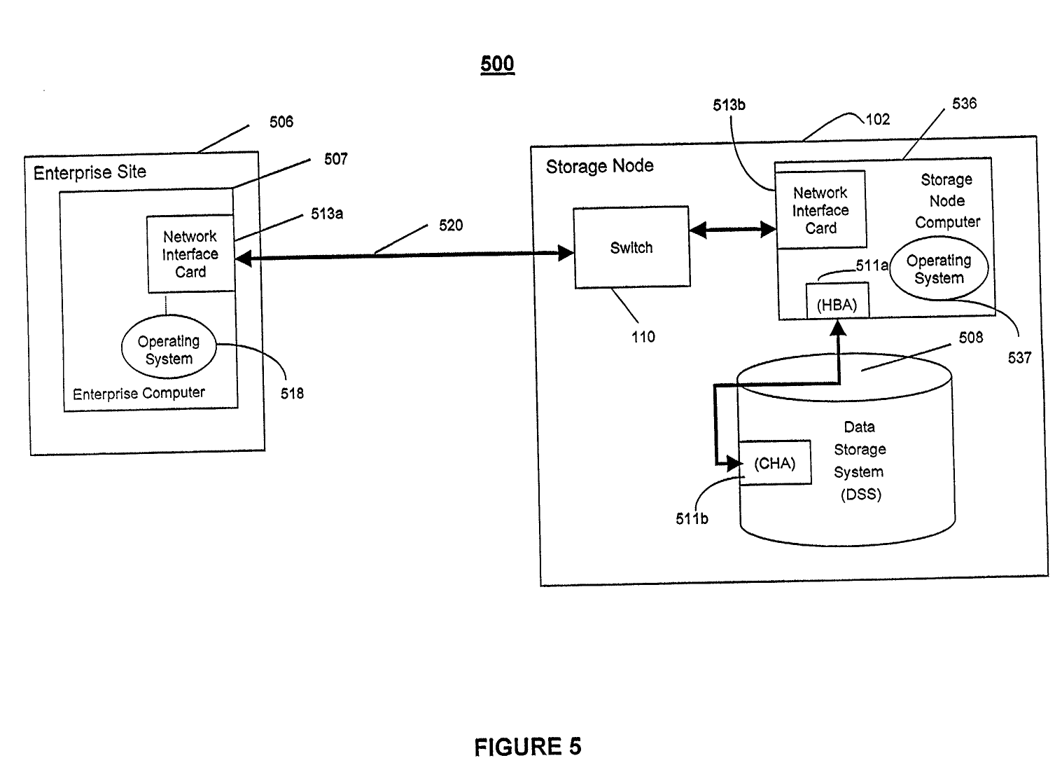

The storage node 102 provides the actual storage capabilities of the storage system 100. As such, the storage node 102 includes a plurality of data storage systems 108a-108n As further discussed below, the illustrative data storage systems 108a-108n have sufficiently high bandwidth and sufficiently low latency performance characteristics to support primary storage services in a manner substantially transparent to the normal operation of executing application programs. Illustratively, the data storage systems 108a-108n can be multi-terabyte units, such as the EMC 3930 (5 terabytes) or the Compac Storage Works RA-8000 (1 terabyte) model units. As such, the data storage systems 108a-108n are capable of providing primary and mirrored storage for the enterprises 106a-106c. As adapted in FIG. 5, the system 100 can also provide network storage for the enterprises 106a-106c. A switch 110 provides a mechanism for multiplexing, and routing data transferred from the enterprises 106a-106c over connections 120a-120c to the data storage systems 108a-108n. The connections 102a-120c, are adapted to support a communication interface between the enterprises 106a-106c and the storage node 102. This communications interface has sufficient performance characteristics to enable non-volatile storage for an enterprise to be located at an extended distance from the enterprise location. A storage manager computer 112 controls the operation of the multiplexing switch 110 and thus, controls the routing of information between the data storage systems 108a-108n and the enterprise sites 106a-106c. The multiplexing switch 110 can also be monitored and controlled from the private network 124 via private network connection 105. According to a further feature, the data storage systems 108a-108n organize information in logical units.

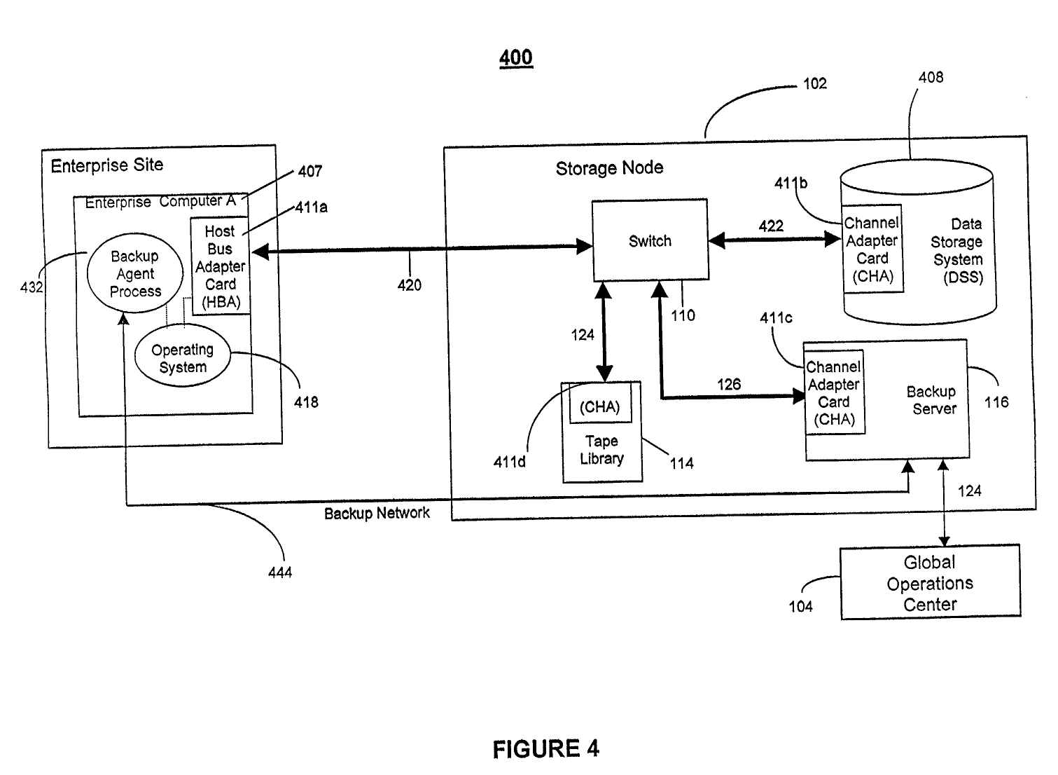

The storage node 112, also controls the operation of the data storage systems 108a-108n, either via the multiplexing switch 110 or the private network 124. The multiplexing switch 110 controls the data flow to and from the data storage systems 109a-108n. The processing of the data flow by the data storage systems 108a-108n is controlled by commands communicated through the private network 124. Private network connections 109a-109n enable all the data storage systems 108a-108n to be monitored and controlled from the storage manager computer 112. The storage node 102 also includes a tape library 114 coupled to the multiplexing switch 112. The tape library 114 illustratively can include magnetic disk, write-able CDROM, magnetic tape and other preferably non-volatile bulk storage devices that provide suitable secondary (non-primary accessed) backup storage for the enterprises 106a-106c. As described in further detail below with respect to FIG. 4, a backup server computer 116 controls operation of the tape library 114. As also discussed with respect to FIG. 4, a backup agent process 432 executing on an enterprise site computer, such as the enterprise site computer 407 of FIG. 4, inter-operates with the backup server computer 116 to control and partially perform backup services.

For the purpose of this disclosure, “primary storage” will refer to information storage and retrieval capabilities of sufficient non-volatility, capacity, and performance to support booting of the operating system executing on the enterprise site computer, swapping of executing application processes, paging of virtual address space pages of applications executing on the enterprise site computer, file systems mounting, and the like. As discussed below, the illustrative storage nodes of the invention support the booting, swapping, paging and file system accessing at performance levels approximating which may be provided by current locally mounted, magnetic “hard disk” devices. As used herein the term “primary storage” excludes tape storage devices, which typically require human intervention and function at performance levels that are non-competitive with magnetic hard disks. Storage devices that require such human intervention and/or temporary files for access are referred to herein as “secondary storage.” Typically, an enterprise site computer uses primary stored information for, among other things, booting the operating system, and enabling the operating system and its application programs to operate. Generally, primary stored information is supplied to a physical address space, such as in RAM of a CPU, in real-time as the CPU demands it via its system address bus. Consequently, the access performance speed requirements for primary stored information are more demanding than that of secondary storage.

According to the illustrative embodiment, the storage system 100 can provide primary storage for information generated by the enterprise sites 106a-106c. The system 100 can also provide mirrored storage of enterprise data generated from the enterprise sites 106a-106c as a method of disaster avoidance and recovery, for enabling testing of application programs, or for enabling generation of test data. Mirrored storage can take the form of providing a mirror copy of primary data stored at the enterprise sites 106a-106c or stored at the storage node 102. By way of example, the enterprise site 106a may choose to have the storage system 100 store with a particular frequency (e.g., hour, minute, second, millisecond, etc.) a dynamic copy of any primary stored information generated at the enterprise site 106a and stored in the data storage systems 108a-108n. This dynamic copy may be overwritten at or below the frequency equal to the storage frequency. In an alternative embodiment, separate dynamic copies can be made and updated each with particular frequency. Up to the second updating or storage frequency functions as a substantially real time copy for backup and recovery applications. Depending upon the service level agreement, data storage associated with disaster recovery can encompass anything from high frequency dynamic copying (mirroring) of all the primary data to providing lower frequency static (snapshot) copying of some portion of the primary data as a backup service. Service level agreements can also specify guaranteed minimum availability of access to stored information factoring planned maintenance and down time, reliability and performance of service, frequency of service and related actions and other related terms and conditions.

To provide primary storage and data mirroring services, the illustrative storage system 100 requires high bandwidth data transfer communication channels between the enterprise sites 106a-106c and the data storage systems 108a-108n. Additionally, the enterprise sites 106a-106c may be located many miles from each other and from the storage system 100. Thus, the illustrative storage system 100 employs high bandwidth data transfer communication channels to transfer data over potentially long distances. For example, according to one embodiment, to enable the storage system 100 to provide primary storage services to the enterprise sites 106a-106e, the illustrative system of the invention employs communication channels with a bandwidth of at least about 10 megabits/second over a distance of at least about 100 feet. According to another embodiment, the illustrative system of the invention employs communication channels with a bandwidth of at least about 1 gigabits/second over a distance of at least about 30 miles. According to the illustrative embodiment, the system of the invention more than achieves such bandwidth versus distance parameters by employing fiber optic communication channels. However, skilled artisans will appreciate that any communication channels that provide sufficient bandwidth over distance transmission characteristics to support the primary and mirrored data storage services provided by the illustrative embodiment of the invention may be employed.

The illustrative storage system 100 provides fiber optic paths 120a-120c for transferring information between the multiplexing switch 110 and the enterprise sites 106a-106c. Additionally, the storage node 102 includes fiber optical paths 122a-122n for transferring information between the multiplexing switch 110 and the data storage systems 108a-108n. The storage node 102 also includes a fiber optical path 124 for transferring information to the tape library 114, and a fiber optical path 126 for transferring information between the multiplexing switch 110 and the backup server computer 116.

In the illustrative example, the storage system 100 employs the Fibre Channel protocol. The Fibre Channel protocol is designed to carry data that may include other higher level protocols. These higher level protocols can be chosen and layered in a variety of ways to suit particular applications that make use of optical communications.

The Fibre Channel protocol is divided into five levels. The lower two protocol levels perform physical link layer type functionality applied to the optical communications media. The upper three protocol levels perform more logical point-to-point addressing and routing functionality. In one alternative embodiment, referred to as “gigabit ethernet,” the upper three Fibre Channel protocol layer functionality is performed and replaced by Internet Protocol (IP). The application of this protocol stack is discussed in further detail below with respect to FIG. 4.

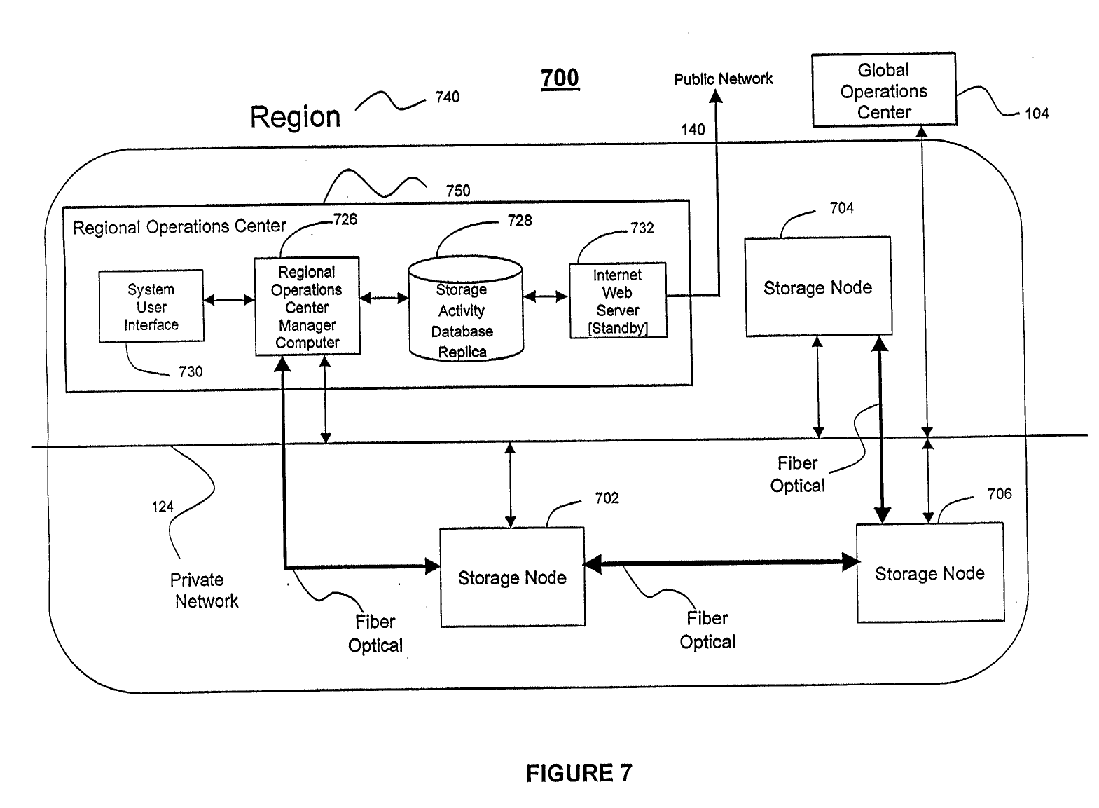

On top of the five Fibre Channel protocol layers, data is carried that may include one or more other higher level protocols. In the illustrative embodiment, the fifth Fibre Channel layer carries the SCSI protocol. The SCSI protocol layer performs device control over a variety of devices, including data storage devices. The entire protocol stack is carried between the enterprise sites 106a-106c and the storage node 102 over one or more Fibre Channel links, which have a current maximum range of about forty miles. Each link has two opposite end points. At one end point, an optical transmitter transmits the Fibre Channel encapsulated data. An optical receiver receives the Fibre Channel encapsulated data at the opposite endpoint of the link The Fibre Channel provides a full duplex link. Thus, information can be transmitted in both directions. Fibre Channel links may be interconnected into a series of links to carry, for example, data between an enterprise site 106a-106c and a storage node 102 or between storage nodes 102. FIGS. 7, 8 and 11 depict illustrative interconnections of storage nodes 102 in this fashion. The Fibre Channel protocol incorporates its own addressing scheme for identifying link end points that constitute a communication path between the starting and ending points of a particular communication link.

In the illustrative embodiment, the invention uses all five Fibre Channel layers to carry the SCSI protocol layer in a point-to-point fashion, between any particular enterprise site and a particular storage node. The SCSI protocol has its own separate, well known addressing scheme for identifying and directing data to a particular data storage system 108a-108n, and its separately addressable internal subsystems and partitions of those subsystems. Data routed between an enterprise site 106a-106c and the storage node 100 may travel through more than one fiber channel communications link.

As mentioned above, the storage system 100 also includes the global operations center 104. The global operation center 104 enables the storage provider to configure one or more storage nodes 102 to support any one of a plurality of possible service level storage agreements entered into with any number of enterprises. The global operation center 104 also enables the storage provider to monitor and control the enterprises' use of the data storage systems 108a-108n and the tape library 114. The global operation center 104 performs configuration, monitoring and control functions by communicating with the backup server computer 116 and the storage manager computer 112 by way of a private communication network or intranet 124. However, in alternative embodiments, the global operation center 104 can perform such communication over a public network, such as the Internet.

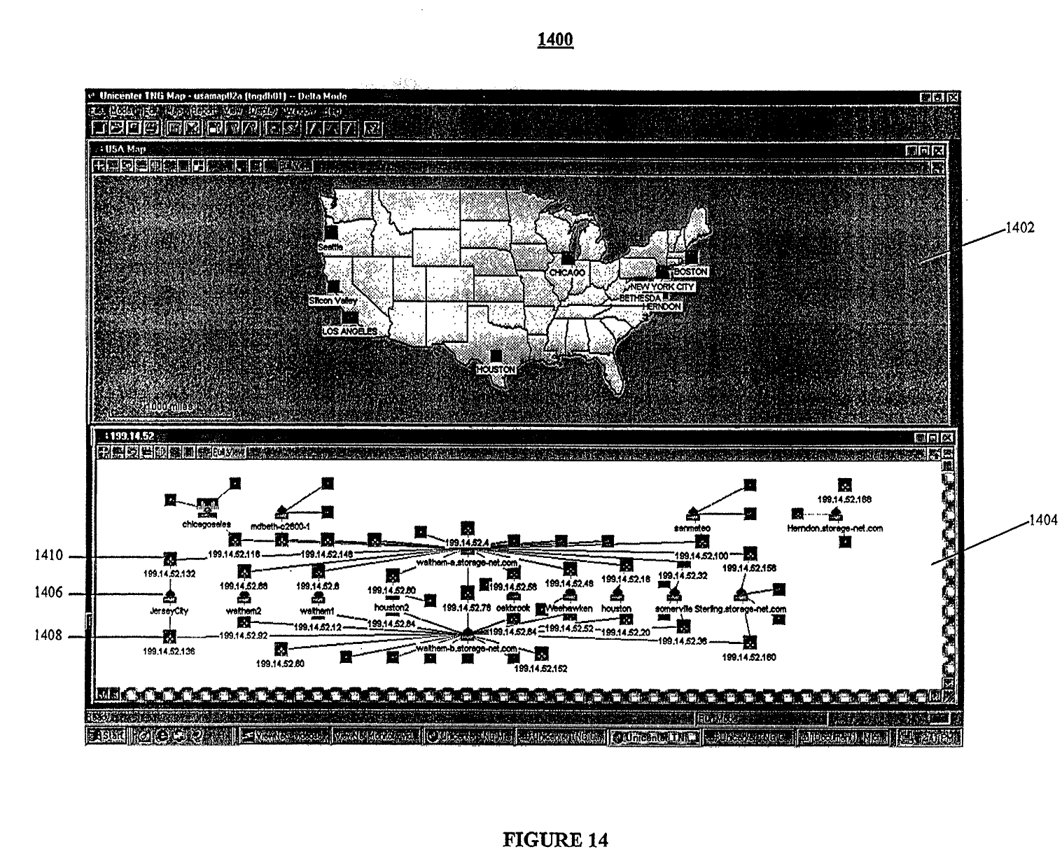

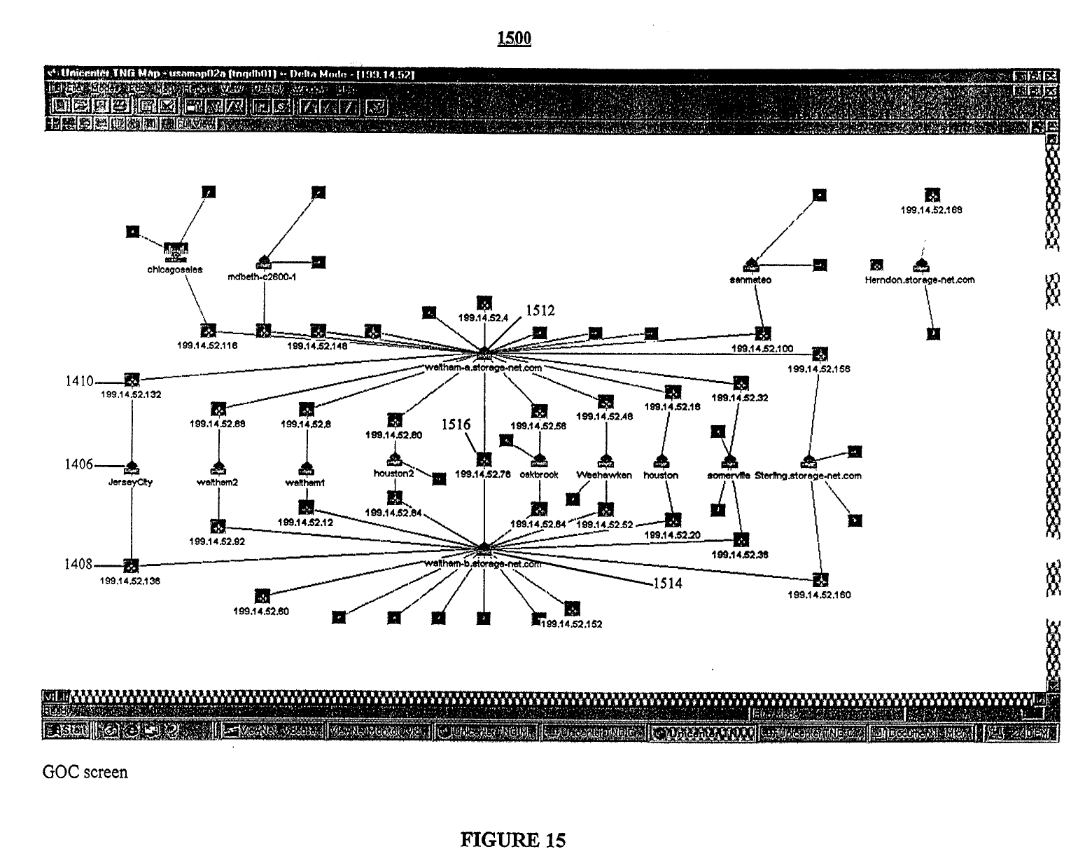

As shown, the global operations center 104 includes a global operations center manager computer 126, which communicates with a storage configuration and activity database 128. The manager computer 126 directly interfaces with a system user interface 130. As described in further detail below with respect to FIGS. 14 and 15, the system user interface 130 includes a graphical user interface that enables the storage provider to visually and interactively monitor and control the operation of the storage system 100 by displaying operational parameters associated with providing information outsourcing to the enterprise sites.

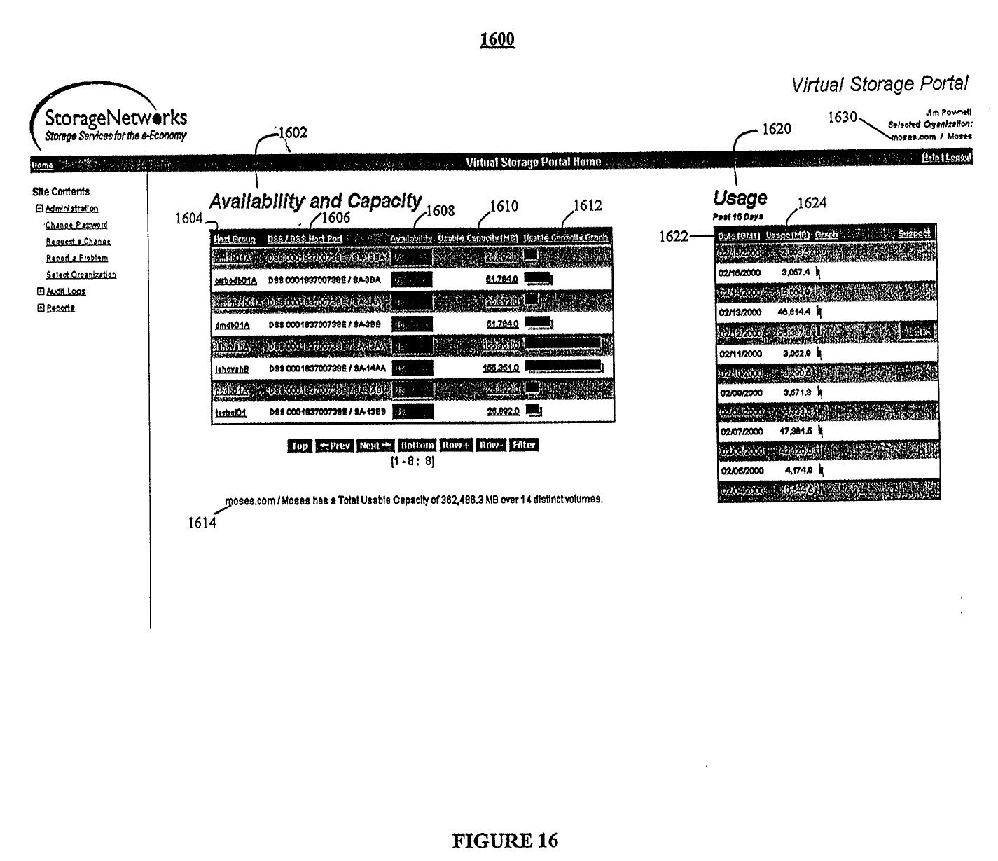

The global operations center manager computer 126 also indirectly interfaces to an Internet Web server computer 132 by controlling the contents of the storage activity database 128. The Web server computer 132 provides a Web-based customer graphical user interface 134. As discussed below in further detail with respect to FIG. 16, the enterprise user interface 134 enables an enterprise to monitor selected operational parameters relating to its use of storage space at the storage node 102, independent of the underlying technological implementation of the storage node 102. Operational parameters can include the amount of storage currently utilized or available to be used, the cost of storage space that has been previously utilized, currently utilized or that is available to be utilized, by the enterprise sites 106a-106c. Enterprises can also employ the enterprise user interface 134 to obtain a cost estimate for reserving a particular amount of storage space, to purchase or reserve additional storage, transiently expand or reduce existing utilized storage, or contract for particular storage services from the storage provider. The information content and capabilities of the enterprise user interface 134 is dictated by the contents of the storage configuration and activity database 128, which is controlled by the global operations center manager computer 126. The global operations center agent software 115, which executes on the storage node manager computer 112, tracks the operation of the multiplexing switch 110, along with each enterprise's usage of the data storage systems 108a-108n. The global operations center agent software 115 transfers tracked information to the global operations center manager computer 126 by way of the private network 124. Preferably, the global operations center agent software 115 utilizes the System Network Management Protocol (SNMP) in combination with the Fibre Channel Protocol (FCP) to recognize (trap) events associated with the multiplexing switch 110. The global operations center manager computer 126 stores the tracked information in the storage activity database 128 for display at the system user interface 130 and for generation of customer-specific information at the Internet-based enterprise user interface 132.

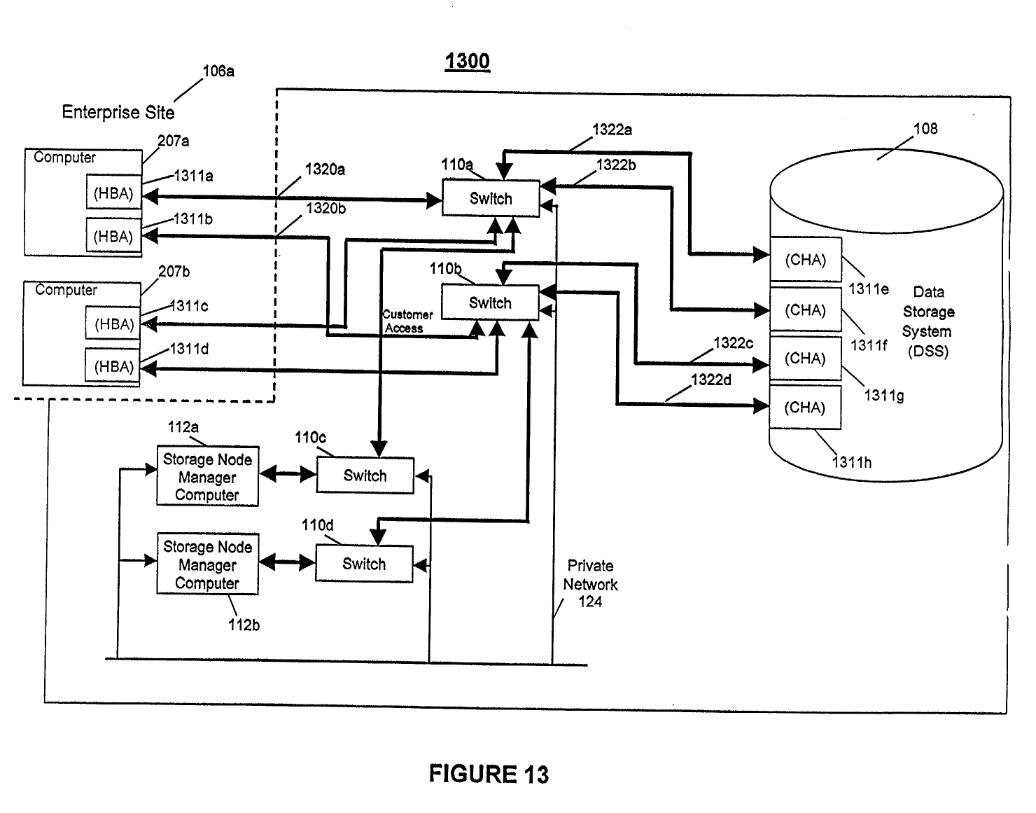

Although FIG. 1 illustratively depicts singular components and connections between singular components, this arrangement may be varied by creating multiple redundant components and/or multiple redundant connections between components. Such an approach is illustratively described with respect to FIG. 13.

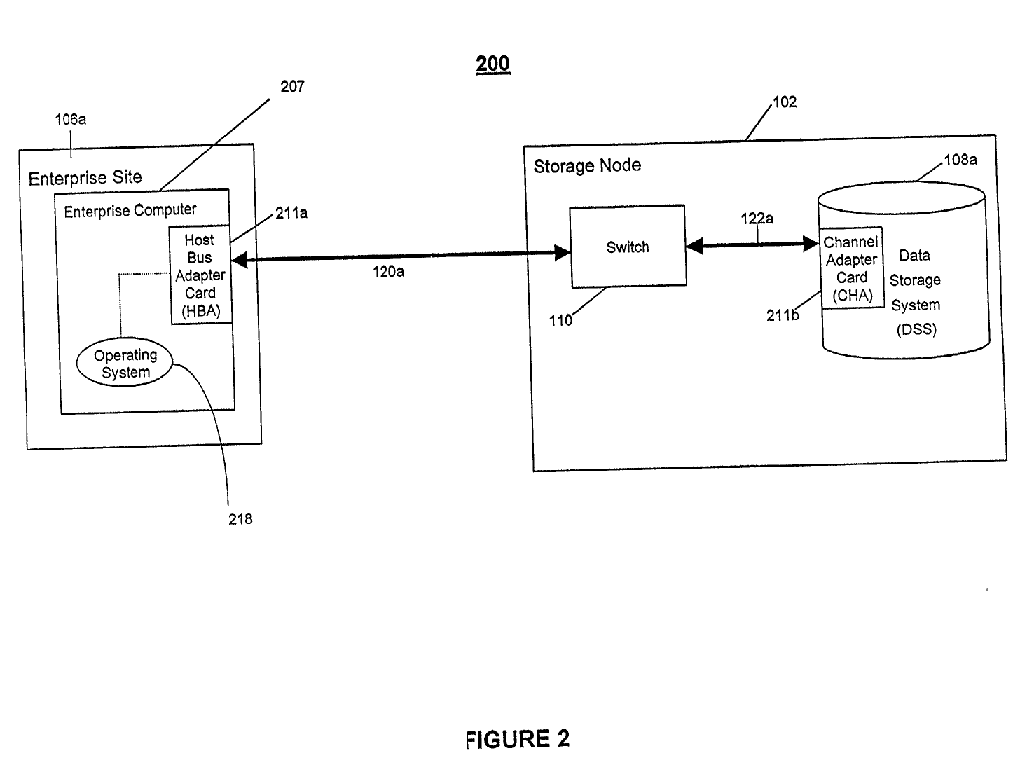

FIG. 2 is a conceptual block diagram 200 of the storage node 102 configured for providing primary storage services to an enterprise site computer 106a according to an illustrative embodiment of the invention. The enterprise site 106a is illustratively configured with an enterprise site computer 207. The enterprise site computer 207 connects to the multiplexing switch 110 through the fiber optical connection 120a. The enterprise site computer 207 interfaces to the fiber optical channel 120a via a host bus adapter card (HBA) 211a. The operating system 218 transfers data to and from the host bus adapter card (HBA) 211a. The storage node 102, located remote to the enterprise site computer 207, contains a data storage system 108a, which functions and interfaces with the enterprise site computer 207 as if it were a SCSI bus connected primary storage device.

Primary storage is demanding in terms of requisite data access speeds. As previously discussed in more detail, primary storage supports booting, swapping, paging and direct file system access with performance substantially transparent to the normal operation of executing application programs. Consequently, information that is primary stored in the data storage system 108a is supplied to the enterprise site computer 106 in real-time as the enterprise site computer 207 demands the information via its system address bus. Also, the operating system 218 can be booted off of the data storage system 108, even though the storage node 102 may be located miles away from the enterprise site computer 207.

The HBA card 211a, creates the illusion to the enterprise site computer 207 that it is an interface to a locally attached data storage system, located proximate to the enterprise site computer 207. However, instead of sending SCSI command messages to a local data storage system, the HBA card 211a transmits SCSI commands over the fiber optical connection 120a, to the multiplexing switch 110. The multiplexing switch 110, routes commands over the fiber optical communications channel 122a to the data storage system 108a The data storage system 108a contains a channel adapter (CHA) card 211b, which interprets the SCSI commands directed to the data storage system 108a from the HBA card 211a. Both the HBA card 211a and the CHA card 211b, perform substantially the same functions in different contexts. The HBA card 211a connects to the system buses of the enterprise site computer 207, whereas the CHA card 211b connects to non-computer devices, such as the data storage system 108a. The signals from the multiplexing switch 110 direct the data storage system 108a to read or write data from or to the data storage system 108a. The data storage system 108a transmits SCSI messages back to the enterprise site computer 207 in response to received SCSI commands from the enterprise site computer 207.

Application programs executing on the enterprise site computer 207, articulate file data input and output commands to the operating system 218 in terms of logical parameters. These parameters refer to file systems. The mapping of file system parameters to the physical block data is performed inside the operating system 218.

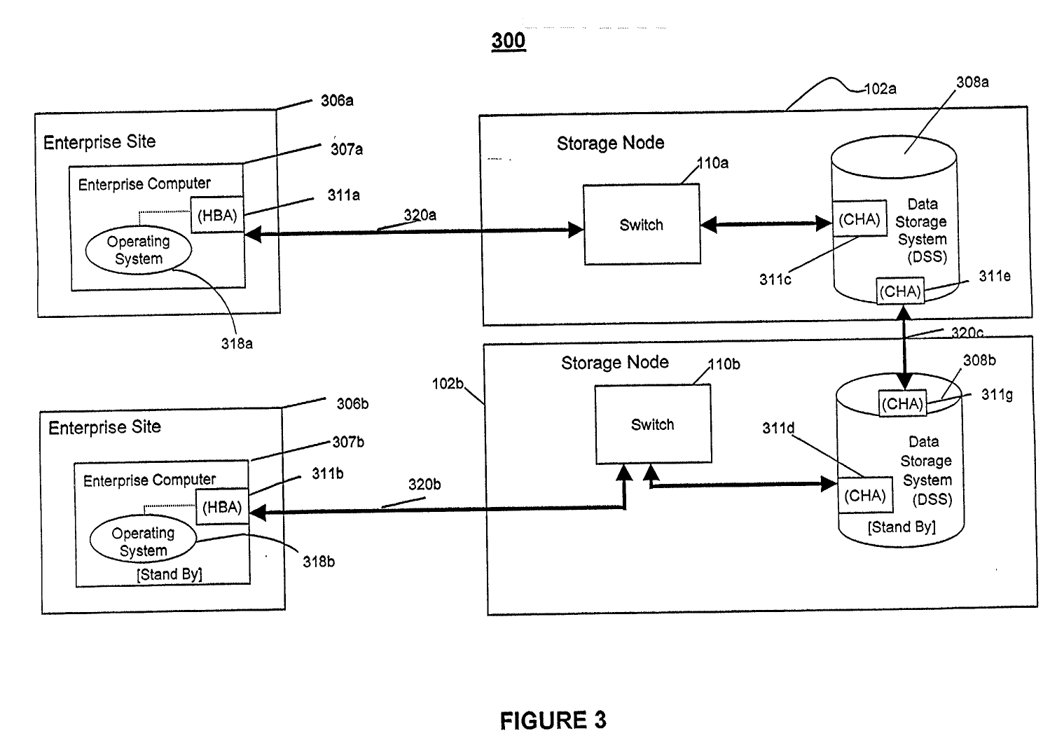

FIG. 3 is a conceptual block diagram 300 of an illustrative storage nodes 102a and 102b, configured for providing mirrored storage services of the primary storage of an enterprise site computer 307a, located at the enterprise site 306a . The storage node 102a, located remote to the enterprise site computer 307a, contains a data storage system 308a, which provides primary storage to the enterprise site computer 307a. A fiber optical channel 320a connects the multiplexing switch 110a to the enterprise site computer 307a.

The enterprise site computer 307b interfaces to the fiber optical channel 320b via the HBA card 311b. The storage node 102b, also contains a standby data storage system 308b, whose contents mirror the contents of the primary data storage system 308a . To provide data mirrored storage, the storage node 102a provides data communicated to data storage system 308a, to data storage system 308b over the fiber optical connection 320c and the CHA cards 311e and 311g.

The diagram 300 includes a standby enterprise site computer 307b located at the second enterprise site 306b. The first and second enterprise sites 306a and 306b may or may not be located remotely from each other. Being located remote from each other can provide each enterprise site with reduced exposure to risks associated with the geographic location of the other enterprise site. For example, risks from weather, natural or man made disasters such as earthquakes or fires may not affect both enterprise site locations. The unaffected enterprise site serves to maintain system availability and reliability. The standby enterprise site computer 307b, couples to the standby data storage system 308b by way of the HBA card 311b, the fiber optical communication channel 320b, the multiplexing switch 110b and the CHA card 311d. In the event of a failure of the enterprise site computer 307a or of the data storage system 308a, the standby enterprise site computer 307b assumes the responsibilities of the failed enterprise site computer 307a and accesses the mirrored data stored on the standby data storage system 308b by way of the HBA card 311b and the fiber optical communication channel 320b. The standby enterprise site computer 307b employs the data stored on the standby data storage system 308b as if is were primary stored data. This configuration, provides disaster avoidance and recovery to the enterprise associated with both enterprise site computers 307a and 307b.

FIG. 4 is a conceptual block diagram 400 of an illustrative storage node 102 configured for providing backup storage services for the primary storage of an enterprise site computer 407. The storage node 102, located remote to the enterprise site computer 407, includes a data storage system 408, which provides primary storage to the enterprise site computer 407. A fiber optical channel 420 connects the multiplexing switch 110 to the enterprise site computer 407. The enterprise site computer 407 interfaces to the fiber optical channel 420 via the HBA card 411a. The storage node 102 also includes a tape library 114 and a backup server computer 116.

The tape library 114 and the backup server computer 116 couple to the multiplexing switch 110, via the fiber optical channel connections 124 and 126, respectively. The backup server computer 116, connects to the multiplexing switch 110, via the fiber optical channel connection 126 and connects to the global operations center 104 via the private network 124. Both the tape library 114, and the backup server computer 116, interface with their respective optical channel connections via resident CHA card 411c and CHA card 411d, respectively. The backup server computer 116 controls operation of the tape library 114, via the communication of SCSI command and response messages between the backup server computer 116 and the tape library 114, through the multiplexing switch 110.

A backup agent process 432, executing on the enterprise site computer 407, communicates with the backup server computer 116, via the backup network 444. Illustratively, and as described with respect to FIG. 1, the backup network 444 is implemented as a “gigabit ethernet” protocol stack. Essentially, the Fibre Channel protocol carries the IP protocol to enable the backup agent process 432 to direct the operation of the backup server computer 116. The backup network 444 may be any communication connection of sufficient accessibility, reliability and bandwidth to support the interoperation of the backup agent process 432 with the backup server 116. The backup network 444 can operate over the fiber optical channel 420, sharing it with other non-backup related communications. Alternatively, the backup network 444 can be the private network 124 of FIG. 1 or can be any other communications channel, fiber optical or otherwise, that meets the above criteria The private network 124, like the backup network 444, can be implemented, for example, by leasing one or more T1 (1.5 megabits/second) connections from telephone service providers.

The backup agent process 432 executes periodically to determine which files stored by the enterprise site computer 407 should be copied for backup purposes. This determination is based upon the criteria specified by the backup storage service level agreement selected by the enterprise associated with the enterprise site computer 407. The backup storage service level agreement specifies, among other things, the portion of the data stored by the enterprise site computer 407 that is to be copied for backup. It also specifies the rules used to determine which files will be copied during each scheduled execution of the backup agent process 432.

Files are typically stored in file systems. The physical storage of a file system as a whole is typically confined to one or more contiguous physical portions of data storage media We refer to a contiguous physical portion of data storage media as a “partition”. Each partition is intended to be a contiguous collection of SCSI addressable physical blocks of uniform size. Each logical division of a data storage system can be mapped to one or more partitions. Backup service level agreements specify which particular backup procedures are to be applied to particular file systems associated with an enterprise site computer 407. Backup procedures can be classified as selective, or non-selective. A non-selective backup procedure copies all files inside of the file system, and is thus referred to as a “full backup” of the file system. A selective backup procedure applies certain criteria to the attributes of files within a file system to determine if the file should be copied at the time of execution of the backup agent process 432. For example, backup criteria may dictate that only files modified after the time of the last execution of the backup agent process 432 will be copied during the current execution of the backup agent process 432. This procedure avoids re-making identical copies of files that have not changed since being copied in a previous execution of the backup agent. This type of backup is referred to as an “incremental backup”. Another type of selective backup, referred to as a differential backup, copies all files modified since the last full backup. Both incremental and differential backups can be referred to as “partial backups” because only a portion of all files copied during a full backup are typically copied during either an incremental or a differential backup.

In one embodiment, backup copies of data are static “snapshots” that are overwritten infrequently, if overwritten at all. Alternatively, backup copies can be overwritten based on a set of rules. For example, in a software development environment, incremental backups beyond a certain age are considered less valuable than full backups of the same age and are overwritten with new incremental backup data. Service level agreements can specify this level of operational detail associated with the backup service provided by the storage provider.

The backup agent process 432 executes on the enterprise site computer 407, and queries the enterprise site computer operating system 418 about attributes associated with files contained within a particular file system scheduled for backup. The backup agent process 432 then compares the attributes with the backup criteria, to determine which files of the file system should be copied during a particular execution of the backup agent process 432. The backup agent process 432 also extracts from the operating system 418 the contents of the physical blocks to be copied. The backup agent process 432 interfaces with the backup server 116 in a plurality of ways. According to one feature, the backup agent process 432 accesses the physical blocks associated with a particular file copied for backup through the enterprise site computer operating system 418. The backup agent process 432 then communicates the contents of the accessed physical blocks to the backup server 116 over the backup network 444.

Alternatively, via the enterprise site computer operating system 418, the backup agent process 432 identifies the location of the physical blocks associated with a particular file copied for backup within a particular partition. The backup agent process 432 then communicates the identity and location of these physical blocks within the partition to the backup server 116 over the backup network 444. This information is referred to as “meta data” as opposed to the actual file content data. The backup server 116 then copies the physical blocks through the multiplexing switch 110 via the fiber optical connections 422 and 126. The backup server 116, receiving either the contents or the location of the physical blocks to be copied, then stores the contents of the blocks associated with each file in tape library 114, as instructed by the backup agent process 432.

In an alternative embodiment, backup copies of data can be stored by the backup server or by a mirroring configuration as shown in FIG. 3, onto on-line accessible media such as a data storage system 408. This embodiment enables the enterprise computer 407 to on-line access backup data with minimum delay, and without delays associated with access to tape media associated with the tape library 114.

FIG. 5 is a conceptual block diagram 500 of an illustrative storage node 102 configured for providing network storage services to support on-line storage requirements of an enterprise site computer 507. The storage node 102, located remote to the enterprise site computer 507, includes a data storage system 508 that stores one or more file systems that are locally mounted onto the operating system 537 of storage node computer 536. Consequently, the operating system 537 of the storage node computer 536 exclusively controls and manages the processing of file system access requests into operations upon physical blocks stored in the data storage system 508.

Application programs executing on the enterprise site computer 507 access files stored by the data storage system 508, by passing operating system specific, logical file system access requests and their associated parameters through the application programming interface of the operating system 518 of the enterprise site computer 507. Both the operating system 518 of the enterprise site computer 507 and its executing applications operate as if the contents of the data storage system 508 were mounted local to the enterprise site computer 507. Conversely, the storage node computer 536 and its operating system 537, rather than the enterprise site computer 507 and its operating system 518, have locally mounted access to the contents of the data storage system 508. Consequently, only the storage node computer operating system 537 has exclusive management, control and knowledge of the internal structure of the file systems stored as contents of the data storage system 508. Nevertheless, the operating system 518 of the enterprise site computer 507 interfaces to its executing application programs in essentially the same manner as if the data storage system 508 were locally mounted onto and managed by the operating system 518 of the enterprise site computer 507.

To accomplish this, the operating system 518 of the enterprise site computer 507 creates an illusion to its locally executing application programs by utilizing the Network File System protocol or some equivalent network file sharing protocol to communicate remote file system access requests and their associated parameters to the storage node computer 536. The enterprise site computer 507 communicates network file system access requests and their associated parameters to the storage node computer 536 while packaged into protocol message transactions; similar to the way in which file system access requests and parameters are expressed by the application programs executing on the enterprise site computer 507 of the operating system 537. These network file system access requests contain no physical block information The operating system 537 of the storage node computer 536 maps the logical file system access requests into local physical block access requests, performs locking on physical blocks to prevent simultaneous write access to each physical block, and then communicates the contents of appropriate physical blocks back to the enterprise site computer 507. The enterprise site computer 507 supplies the file system data to its executing application programs as if the file system was locally mounted and managed by the operating system 518 of the enterprise site computer 507. Although this configuration can perform well enough to be transparent to the execution of many types of application programs executing on the enterprise site computer 507, there is a small but measurable performance penalty for this configuration as compared to the enterprise site computer 507 locally mounting and managing the remotely located data storage system 508, as shown in FIG. 2.

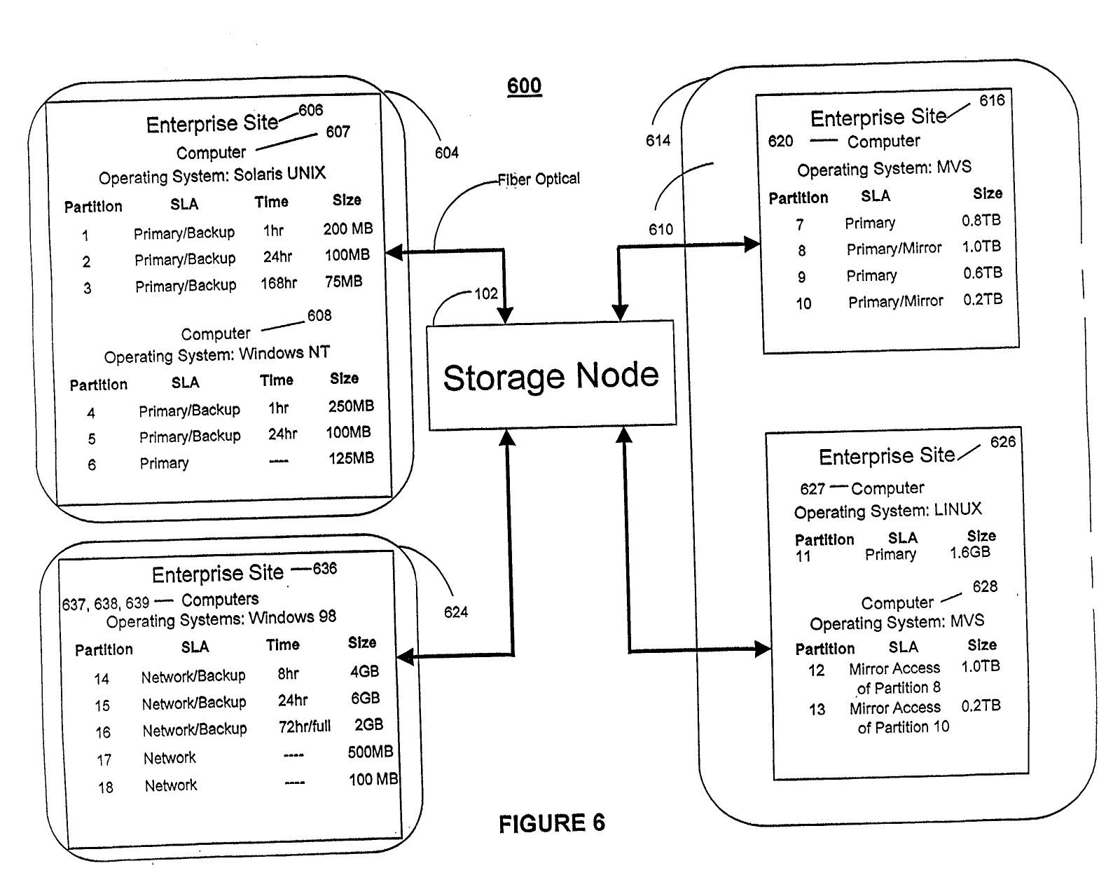

FIG. 6 is a conceptual block diagram 600 of a storage node 102 illustratively configured for providing storage services to support storage requirements of multiple, geographically disbursed enterprise sites associated with different enterprises. The storage node 102 is configured for providing different types and levels of service, as specified by each service level agreement between the storage provider and the enterprise, associated with each serviced enterprise site. The storage node 102 may also be used as a vehicle to affect information sharing between enterprise sites 606, 616, 626 and 636.

The storage node 102, provides the enterprise site 606, associated with the enterprise 604, with primary storage according to the terms of a primary storage service level agreement. The storage node 102 also provides backup service to a portion of the primary stored information according to a backup service level agreement The enterprise site 606 has two enterprise site computers 607 and 608, each, for example, executing a different operating system. The enterprise site computer 607, for example, executing the Solaris™ UNIX™ operating system, uses three partitions (1, 2 and 3) of varying size. Similarly, the enterprise site computer 608, executing for example, the Microsoft™ Windows™ NT operating system, also uses three partitions (4, 5 and 6) of varying size. Together, both enterprise site computers use 850 megabytes of primary stored information. As indicated, the storage node 102 performs selective backup on partitions 1 and 4 hourly, on partitions 2 and 5 daily (every 24 hours), and on partition 3 weekly (every 168 hours). Partition 6 does not receive any backup service. Illustratively, the enterprise site 606 is located ten miles west of the storage node 102 site location.

According to another illustrative service level agreement, the storage node 102 provides the enterprise site 616, associated with the enterprise 614, with primary storage for four partitions (7-10). According to an illustrative mirroring service level agreement, the storage node 102 also provides mirroring services to partitions 8 and 10. The enterprise site 616 has one enterprise site computer 620. The partitions (7-10) are of varying size and total 2.6 terabytes of primary stored information. Information stored in the two partitions 8 and 10, which require mirroring services, total 1.2 terabytes. Illustratively, the enterprise site 616 is located 14 miles north of the storage node 102 site location.

The enterprise site 626 includes two enterprise site computers, 627 and 628. According to the terms of a primary storage level agreement between the enterprise 614 and the storage provider, the storage node 102 provides the enterprise site computer 627 with primary storage for partition 11. According to a mirroring service level agreement, the storage node 102 provides the enterprise site computer 628 with mirrored access to the partitions 8 and 10 of the enterprise site computer 620. Such access is provided through the partitions 12 and 13, respectively, of the enterprise site computer 628. Illustratively, the enterprise site 626 is located 18 miles south of the storage node 102 site location.

The storage node 102, also provides the enterprise site 636, associated with the enterprise 614, with network storage service for five partitions accessible on three enterprise site computers 637, 638, and 639, according to the terms of a network storage service level agreement between the enterprise 624 and the storage provider. In this illustrative example, all three enterprise site computers 637-639 are personal computers executing the Windows™ 98 operating system. All three enterprise site computers 637639 have both read and write access to files within any of the five shared partitions 14-18. A file locking mechanism exists to prevent write access by more than one enterprise site computer to any one file at any one time.

The storage node 102, illustratively, includes a storage node computer running Solaris™ UNIX™ that provides network file access to the three personal computers. According to a network storage level service agreement between the enterprise 624 and the storage provider, the storage node 102 also provides backup to twelve gigabytes of the partitions 14-16 of the network storage of the enterprise site 636. The enterprise site 636 is illustratively located 12 miles southwest of the storage node 102 site location.

FIG. 7 is a conceptual block diagram 700 depicting multiple storage nodes 702-706 located within a region 740 and in communication with a regional operations center 750 over the private network 124. The regional operations center 750, functions in a similar fashion to a combination of a storage node 102 and a global operations center 104. The regional operations center 750 includes a regional operations center management computer 726, which has a connection over the private network 124 to the global operations center manager computer 126, and has a direct fiber optical connection to at least one storage node 702 within the region 740. Illustratively, each storage node 702, 704 and 706 is fiber optically connected to at least one other storage node in the region 740 in such a manner that the regional operations center 750 has a direct or indirect fiber optical connection to every storage node 702, 704 and 706 in the region 740. In alternative embodiments, a storage node, such as storage nodes 702, 704 and 706, only has a fiber optical connection with an enterprise site and no other entity.

The regional operations center 750 also contains a system user interface 730 connected to the regional operations center management computer 726. The system user interface 730 enables the regional operations center 750 to monitor the activities of the storage nodes 702, 704 and 706 within the region 740 in a similar manner to the way the global operations center 104 monitors such activity across all regions. The global operations center agent 115, executing on each storage node manager computer 112, communicates activity monitoring information that can be accessed by the global operations center management computer 126 or the regional operations center management computers 726.

The regional operations center 750, can serve as a central permanent location to house operational staff. However storage nodes, are not intended to require the permanent presence of operational staff and are preferably unmanned. The system user interface 730 of the regional operations center 750 enables operational staff to identify and respond to situations requiring attention at any of the storage nodes 702, 704 and 706.

The regional operations center 750 also can consolidate storage node equipment for the region 740. For example, the tape library 114 and/or the backup server 116 can be located inside the regional operations center 750 and shared among the storage nodes 702, 704 and 706 within the region 740. Illustratively, the backup agents 432, executing on the enterprise site computers serviced by storage nodes 702, 704 and 706 can be configured to communicate over a backup network 444 linking the regional operations center 750 to all of the enterprise sites.

In a further illustrative embodiment, the regional operations center 750 includes a replica 728 of the global operations center storage activity database 128. The replica 728 can be periodically updated with the most current information from the global operations center 104. In the event that the global operations center 104 becomes unavailable for customer access, the regional operations center 750, provides the replica 728 of the storage activity database 128 to the global operations manager computer 126 and to the Internet Web Server 132 via the private network 124. The regional operations center 750 can also use the replica 728 of the storage activity database 128 to provide information over the public network 140 enterprises. The regional operations center, optionally, can also substitute for the global operations center 104 to collect re-directed information from global operations center agent 115 gathered in real-time and communicated over the private network 124.

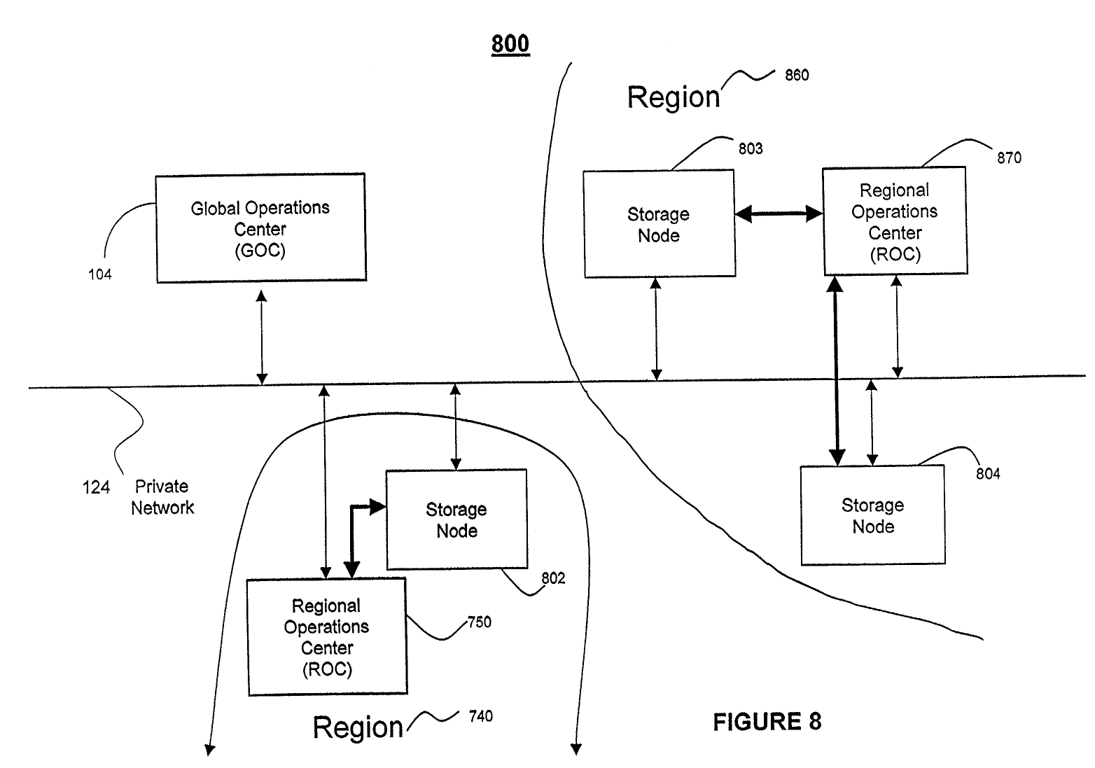

FIG. 8 expands upon FIG. 7, providing a conceptual block diagram 800 depicting multiple service regions 740 and 860 containing regional operations centers 750 and 870, respectively, and their associated storage nodes 802, 803 and 804. The storage node 802, located in region 740, and the storage nodes 803 and 804, located in region 860, are depicted. All are in communication with the global operations center 104 over the private network 124.

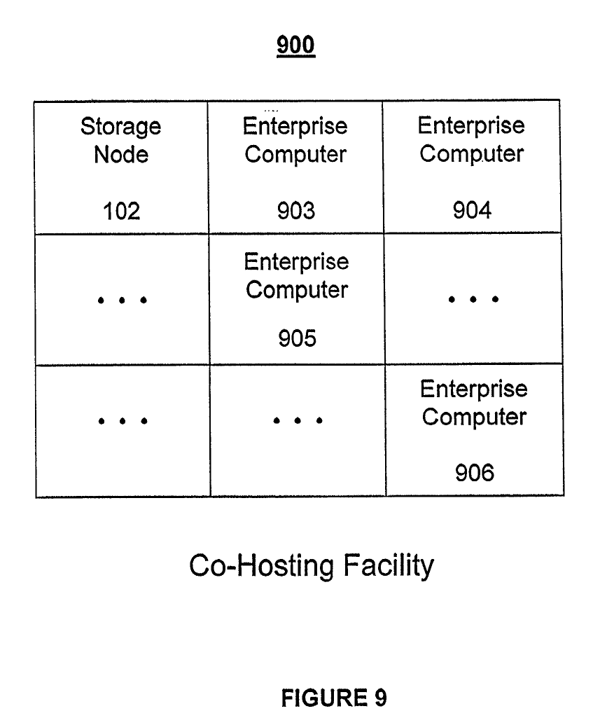

FIG. 9 is a conceptual block diagram depicting illustrative co-hosting facility site 900 that includes the storage node 102 and the enterprise site computers 903-906. The enterprise site computers 903-906 are associated with a variety of enterprises. In this illustrative embodiment, the enterprise site computers 903-906, are located within close proximity to the storage node 102, and not located at an enterprise site remote to the location of the storage node 102. According to the illustrative example of FIG. 9, the storage node 102 and the enterprise site computers 903-906 are preferably located within the same building or located in nearby or adjacent buildings.

Illustratively, the storage node 102 and one or more of the enterprise site computers 903-906 are clustered within proximity to each other to share some advantage of a particular location. For example, the co-hosting facility site 900 may provide high bandwidth access to the Internet, which an enterprise cannot feasibly obtain from other remotely located enterprise site locations.

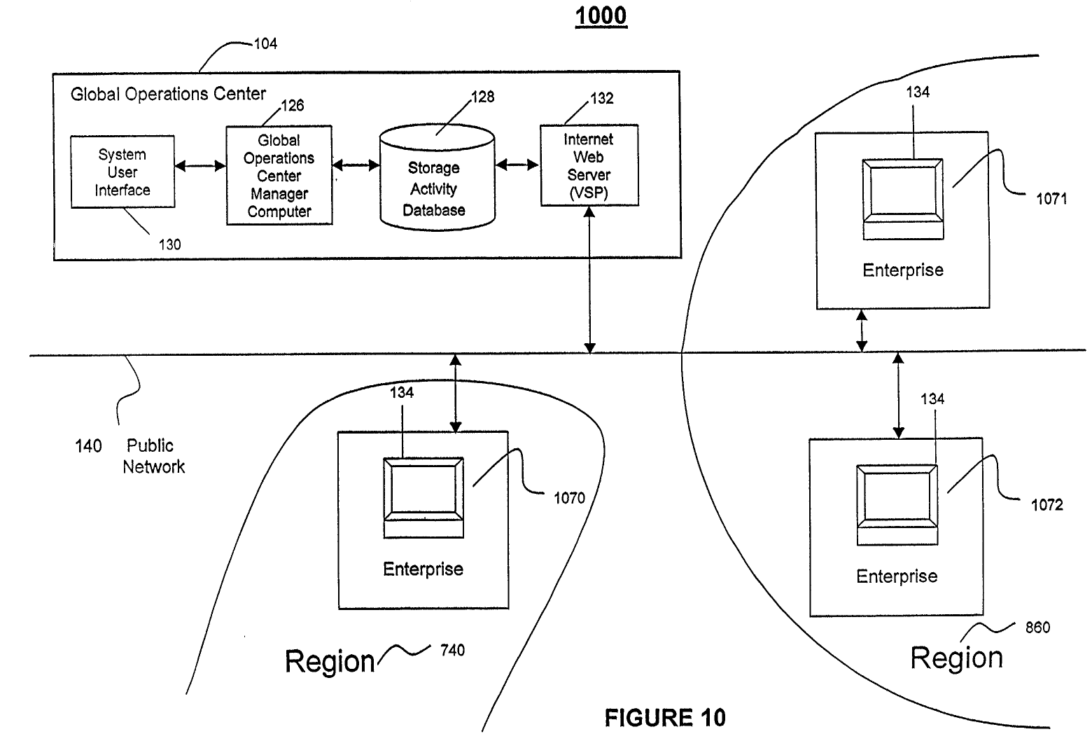

FIG. 10 is a conceptual block diagram 1000 depicting enterprise sites 1070-1072 located within regions 740 and 860, each equipped with an enterprise user interface 134, and in communication with the global operations center 104 over a public network 140, preferably the Internet. The global operations center 104 houses an Internet Web server computer 132 that is accessed as an Internet Web site. The Web server computer 132 presents a visual and interactive enterprise user interface 134 through an Internet browser program associated with an enterprise, located at an enterprise site 1070-1072.

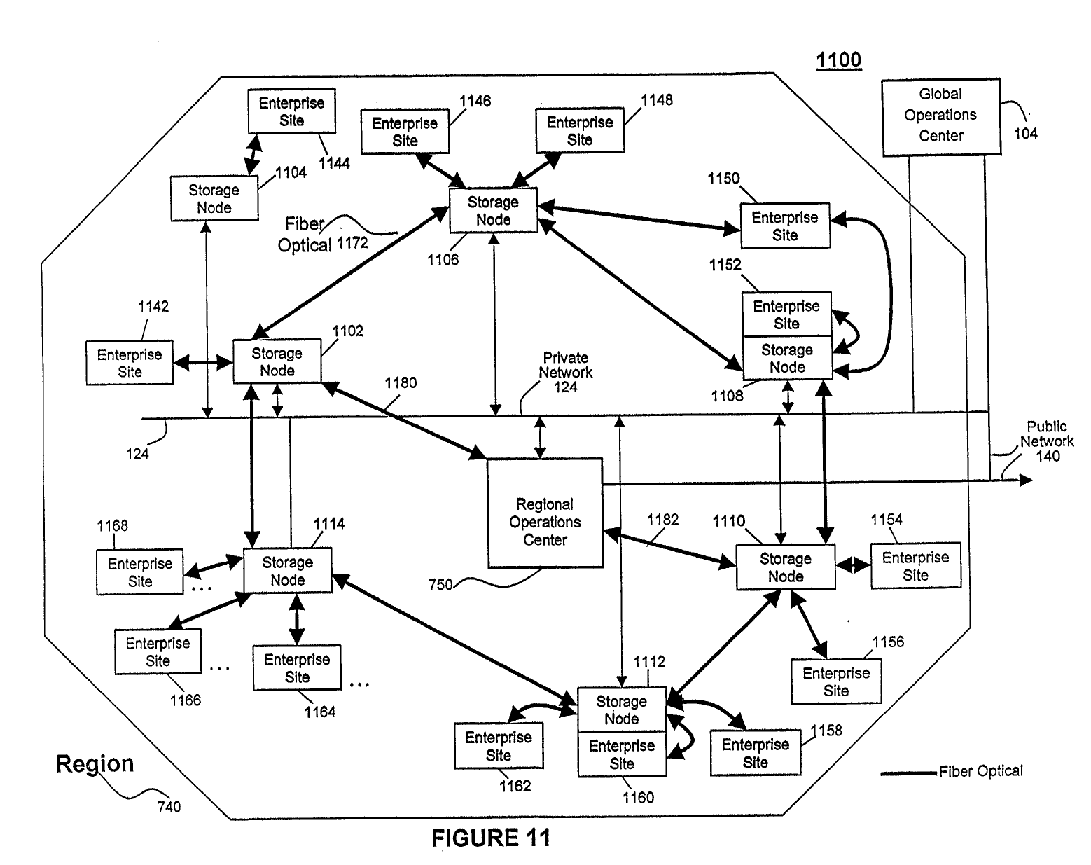

FIG. 11 is a conceptual block diagram 1100 depicting a variety of storage node and enterprise site configurations within a single region 740. Region 740 contains multiple storage nodes 1102-1114, fiber optically connected to their associated enterprise sites 1140-1168. All storage nodes 1102-1114, the regional operations center 750 and the global operations center 104 are connected to the private network 124. The regional operations center 750 and the global operations center 104 are also both connected to the public network 140.

Illustratively, every enterprise site has at least one direct fiber optical connection to an associated storage node. For example, the enterprise site 1150, has two associated storage nodes 1106 and 1108, and a direct fiber optical connection to each associated storage node 1106 and 1108. Except for storage node 1104, every storage node in the region 740 has at least one direct connection to another storage node in the region 740. By way of example, the storage node 1102 has a direct fiber optical connection 1172 to the storage node 1106. The storage node 1104 is the only storage node in the region 740 configured without any fiber optical connection, direct or indirect, to another storage node in the region 740. Thus, the storage node 1104 operates as an “island” of storage.

The regional operations center 750 has at least one fiber optical connection to at least one storage node in the region 740. By way of example, the regional operations center 750 has a fiber optical connection 1180 to the storage node 1102, and a fiber optical connection 1182 to the storage node 1110. Consequently, the regional operations center 750, and all of the storage nodes, except for the storage node 1104, have a fiber optical connection, directly or indirectly, with every other storage node in the region 740. Both storage nodes 1108 and 1112, are located adjacent to their associated enterprise sites 1152 and 1160 respectively.

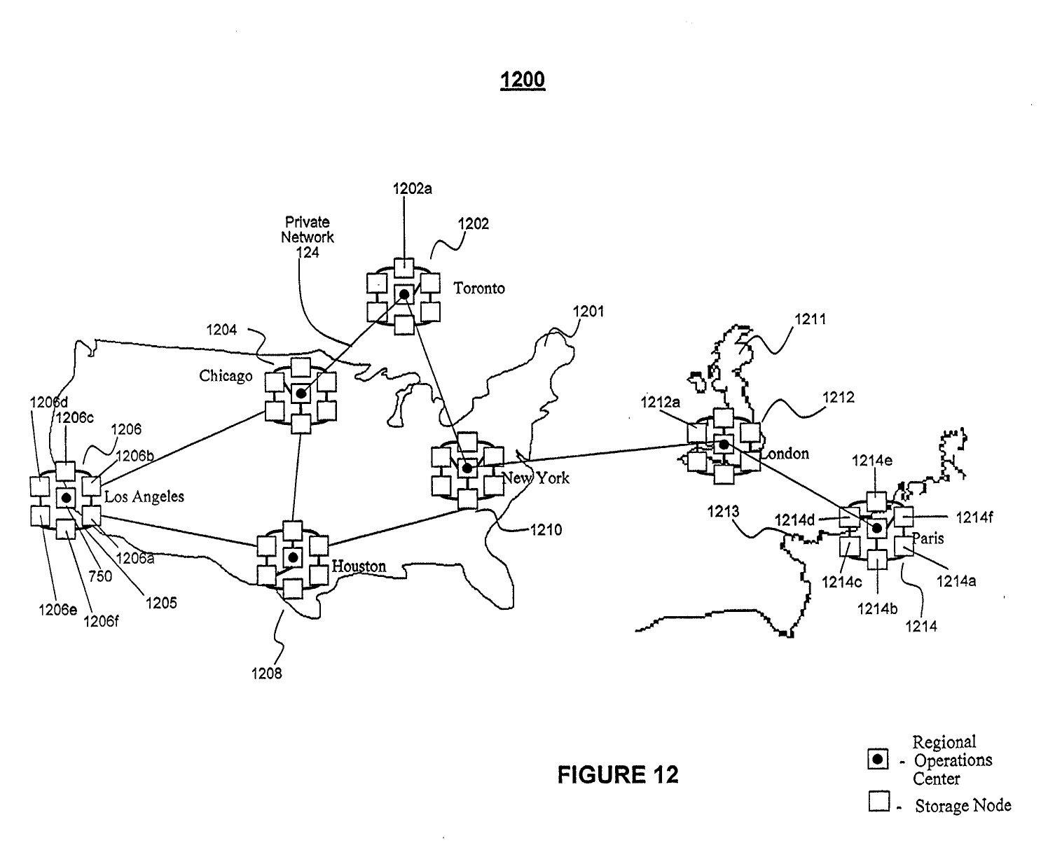

FIG. 12 is a conceptual map diagram 1200 depicting storage nodes grouped into regions 1202, 1204, 1206, 1208 and 1210, located in various metropolitan areas through out North America 1201. Each region 1202, 1204, 1206, 1208 and 1210 contains a regional operations center that has at least one fiber optical connection to at least one storage node located in the same region. For example, the region 1206 includes a regional operations center 750, which optically connects to the storage nodes 1206a and 1206c. Additionally, the storage nodes 1206a-1206f are optically connected to a “ring” topology. This “ring” topology is similar to the topology depicted in FIG. 11. Although interconnections between the storage nodes within a region need not be limited to a “ring” topology, it is advantageous for each storage node in the region, such as region 1206, to be connected to at least one other storage node in the region, and for there to be at least an indirect path of connections between any two storage nodes in the region, and between any storage node and the regional operations center 750, in the region.

The private network 124, connects to each region's regional operations center 750. The storage nodes in each region are also connected to the portion of the private network 124 associated with each region.

This illustrative embodiment enables information originating at any one storage node in any region 1202-1214, to be copied to any other storage node located in any region 1202-1214. By way of example, information can be copied from the storage node 1206b located in the region 1206 (i.e., the Los Angeles metropolitan area) to the storage node 1214a located in the region 1214 (i.e., the Paris metropolitan area).

Furthermore, information may be distributed, i.e. copied multiple times in a parallel fashion, from any one storage node in any region 1202-1214, to any subset or all of the storage nodes located in any subset or all of the regions 1202-1214. Illustratively, the inter-regional copying of information is communicated over the private network connecting regional operation centers located in separate regions 1202-1214, or alternatively over a public network, such as the Internet. Intra-regional copying is communicated either over a fiber optical communication path connecting storage nodes within a region, or over the private network 124, or routed over parts of either the fiber optical communications path or the private network 124 with a region. By way of example, digitally encoded audio and/or visual information, such as for example, movies, may be distributed around the world from one storage node, such as from storage node 1206c, to any or all of the other storage nodes located in any of the regions 1202-1214.

FIG. 13 depicts illustrative dual redundant connections between a pair of enterprise site computers 207a and 207b, a first pair of multiplexing switches 110a and 110b, a pair of storage node manager computers 112a and 112b, and a second pair of multiplexing switches 110c and 110d. Each pair of multiplexing switches act as one switch. At any one time, one member of a pair is active and the other member of the pair is passive. If the active multiplexing switch becomes disabled, the other passive multiplexing switch becomes active to replace the previously active multiplexing switch. The same dual redundant principal applies to the pair of enterprise site computers 207a and 207b, and to the pair of storage manager computers 112a and 112b.

This embodiment can be varied and enhanced in many ways. For example, any pair of components can be replaced by a single component with dual connections to other connected components. Additionally, any pair of enterprise site computers 207a and 207b can be replaced by a single enterprise site computer with dual connections to other components. This type of substitution, in theory reduces the redundancy and the reliability of the entire configuration, but enables enterprises to contract through service level agreements for only a desired level of reliability. Additionally, this embodiment can also be applied to the mirroring services depicted in FIG. 3. For example, each enterprise site 306a and 306b, and storage node 102a and 102b, can be configured to be dual redundant as depicted in FIG. 13.

Optionally, the enterprise site 106a can use dual redundant enterprise site computers 207a and 207b, each with a separate connection to each multiplexing switch 11Oa and 110b in the dual redundant pair. Alternatively, the enterprise site 106a can use one enterprise site computer with two fiber optical connections, one separate connection to each multiplexing switch 110a and 110b in the dual redundant pair.

In an alternative embodiment, multiple enterprise site computers located at one enterprise site may each have at least one access point on one or more connections 1320a-1320d. Multiple access points to one storage node connection 1320a-1320d can enhance the reliability and bandwidth of access to the remotely stored information. If one enterprise site computer 207a-207bbecomes disabled, another enterprise site computer with access to the same connection 1320a-1320d, can maintain enterprise site access over the same connection 1320a-1320d.

FIG. 14 is an example of one of a plurality of system user interface screens 1400, which displays both a geographical map of the United States 1402 and a map 1404 of the private network 124 with respect to its connections to storage nodes and their associated network switching equipment. In this embodiment, the private network 124 employs the Internet protocol (IP) to route data between the storage nodes 102. The private network map 1404, consists of nodes that are labeled either with names such as “JerseyCity” (1406) or that are labeled with numbers such as “199.14.52.136” (1408). Nodes labeled with names 1406 are constructed in accord with the illustrative storage node 102. The “JerseyCity” storage node 1406 is located in the vicinity of Jersey City, N.J. Nodes labeled with numbers, such as the nodes 1408 and 1410, are IP routing devices associated with the nearest adjacent and directly connected storage node 1406. The labeled number associated with an IP routing device 1408 or 1410 is the actual IP address for that routing device. In this embodiment, each IP routing device is physically inside or nearby to its associated storage node 1406.

FIG. 15 depicts an expanded view of the private network map 1604. The “JerseyCity” storage node 1406, is directly connected to two nearby adjacent IP router devices “199.14.52.136” (1408) and “199.14.52.132” (1410) of the private network 124 in dual redundant fashion. Each adjacent IP router device 1408 and 1410 is directly connected to the storage nodes “waltham-astorage-net.com” (1512) and “waltham-b.storage-net.com” (1514), respectively. Both of the storage nodes 1512 and 1514 are directly connected together through another IP routing device “199.14.52.76” (1516). This configuration provides dual redundancy to all of the three aforementioned storage nodes 1406, 1512 and 1514. Among these three storage nodes 1406, 1512 and 1514, if one connection to a particular storage node destination should become disabled, there exists another alternative path of connections to the same storage node destination. For example, if the connection between storage nodes 1406 and 1512 by way of IP router 1410 were disabled, the path of connections between 1406 and 1512 by way of IP router 1408 could be utilized as an alternative path of communication.

FIG. 16 is an illustrative embodiment of one of a plurality of enterprise user interface screens 1600, which displays availability, capacity and usage information in a table format as it applies to the “moses.com” (1630) enterprise. The availability and capacity table 1602 lists the availability status and usable capacity of each data storage system and host port pairing 1606. For this embodiment, a host port is one fiber optical connection between a storage node and an enterprise site. A data storage system within the storage node 102, is associated with each host port 1606. A host group is the group of one or more enterprise site computers that are connected onto a particular host port 1606.

The “Availability” column 1608 provides the status of a particular host port identified by a row entry in the DSS/DSS Host Port 1606 column. The availability status of a host port is expressed as either “UP” indicating the host port is available, or “DOWN” indicating the host port is unavailable. As depicted for the current time, all host ports listed in the DSS/DSS Host Port 1606 column are “UP”.

The “Usable Capacity” column 1610, indicates that maximum amount of storage available to be used for a particular host port. Each host port is identified by a particular column entry in the “DSS/DSS Host Port” column 1606. The maximum amount of storage available to be used is indicated by column entry in the “Usable Capacity” column 1610. The maximum amount of storage available to be used for a given host port date is matched by “Usable Capacity” 1610 and “DSS/DSS Host Port” 1606 column entries located in the same row. Storage is expressed in units of megabytes (MB). The “Usable Capacity Graph” column 1612, provides a visual horizontal bar that is proportional in size to the “Usable Capacity” 1610. Total usable capacity 1614 for all host ports is indicated below the availability and capacity table 1602.

The “Usage” table 1620, indicates the actual amount of storage accessed or re-accessed on a per day basis. Each date is indicated by a particular column entry in the “Date” column 1622. Total storage accessed or re-accessed for a particular date is indicated by a particular column entry in the “Usage” column 1624. Usage for a particular date is matched by “Date” and “Usage” column entries located in the same row. For example, 4333.6 MB were accessed or re-accessed on Feb. 08, 2000. Note that the amount of storage accessed or re-accessed can exceed the total storage capacity of a particular host port. The same blocks of storage and be re-read and/or re-written many times in a particular day.

The invention may be embodied in other specific forms without departing from the spirit or essential characteristics thereof. The above described embodiments are therefore considered in all respects illustrative and not restrictive. Thus, the scope of the invention is indicated by the appended claims, rather than the foregoing description.

What is claimed is:

1. A method for providing information storage outsourcing comprising,
providing a first storage node,
enabling a plurality of enterprises that are located remotely with respect to said first storage node to communicatively couple to said first storage node by way of first communication channels having sufficient performance characteristics to enable said first storage node to provide primary storage services to said plurality of enterprises;
enabling said plurality enterprises to transfer information to and from said first storage node by way of said first communication channels, and
storing information transferred from said plurality of enterprises at said first storage node.

2. A method for providing information outsourcing according to claim 1, further comprising, providing at least a first of said plurality of enterprises with on-line access to information stored at said first storage node.

3. A method for providing information outsourcing according to claim 1, further comprising, enabling at least a first of said plurality of enterprises to copy selected information from said first enterprise to said first storage node to provide a snapshot copy of said selected information, wherein said snapshot copy enables said first enterprise to recover said selected information from said first storage node.

4. A method for providing information outsourcing according to claim 3, further comprising, enabling said first enterprise to have on-line access to said snapshot copy of said selected information.

5. A method for providing information outsourcing according to claim 1, further comprising, enabling at least a first of said plurality of enterprises to copy selected information in substantially real-time to said first storage node to provide a substantially real-time backup copy of said selected information.

6. A method for providing information outsourcing according to claim 1, further comprising, enabling at least a first of said plurality of enterprises to enter a request to reserve an amount of storage space at said first storage node.

7. A method for providing information outsourcing according to claim 6, further comprising, enabling said first enterprise to enter a request to update said amount of reserved storage space at said first storage node.

8. A method for providing information outsourcing according to claim 6, further comprising, reserving said amount of storage space in response to said request.

9. A method for providing information outsourcing according to claim 6, further comprising, enabling said first enterprise to transiently expand an amount of utilized storage space at said first storage node beyond said reserved storage space, without updating said amount of reserved storage space.

10. A method for providing information outsourcing according to claim 1, further comprising, enabling at least a first of said plurality of enterprises to monitor an amount of storage capacity utilized by said first enterprise at said first storage node.

11. A method for providing information outsourcing according to claim 1, further comprising, enabling at least a first of said plurality of enterprises to query said first storage node as to a cost of reserving a particular amount of storage space at said first storage node.

12. A method for providing information outsourcing according to claim 1, further comprising,
coupling said first storage node to a communication network, and
enabling at least a first of said plurality of enterprises to communicate with said first storage node by way of said communication network.

13. A method for providing information outsourcing according to claim 12, wherein said communication network is the Internet.

14. A method for providing information outsourcing according to claim 12, further comprising, enabling said first enterprise to reserve an amount of storage space at said first storage node by communicating a reservation over said communication network.

15. A method for providing information outsourcing according to claim 12, further comprising, enabling said first enterprise to update said amount of reserved storage space by communicating an updated reservation over said communication network.

16. A method for providing information outsourcing according to claim 12, further comprising, enabling said first enterprise to monitor an amount of storage capacity utilized by said first enterprise at said first storage node by communicating with said first storage node over said communication network.

17. A method for providing information outsourcing according to claim 12, further comprising, enabling said first enterprise to query said first storage node over said communication network to obtain a cost estimate of reserving a particular amount of storage space at said first storage node.

18. A method for providing information outsourcing according to claim 11, further comprising providing a service level agreement between said first enterprise and said first storage node, wherein said service level agreement specifies at least in part a guaranteed availability of information stored by said first enterprise at said first storage node.

19. A method for providing information outsourcing according to claim 11, further comprising providing a service level agreement between said first enterprise and said first storage node, wherein said service level agreement specifies at least in part a guaranteed frequency of snapshot copying of information stored by said first enterprise at said first storage node.

20. A method for providing information outsourcing according to claim 1, further comprising, providing at said first storage node primary storage for at least a first of said plurality of enterprises.

21. A method for providing information outsourcing according to claim 1, further comprising, enabling transfer of information between said first storage node and at least a first of said plurality of enterprises in a manner that is substantially transparent to application programs executing at said first enterprise.

22. A method for providing information outsourcing according to claim 1, further comprising, providing said first storage node at a distance of at least about one hundred feet from at least a first of said plurality of enterprises.

23. A method for providing information outsourcing according to claim 1, further comprising, mirroring selected information from at least a first of said plurality of enterprises to said first storage node to generate a dynamic copy of said selected information at said first storage node.

24. A method for providing information outsourcing according to claim 23, further comprising, updating said copy of said selected information in substantially real-time.

25. A method for providing information outsourcing according to claim 1, further comprising, locating said first storage node sufficiently remote from at least a first of said plurality of enterprises to provide an increased likelihood of said first storage node surviving destruction of said first enterprise.

26. A method for providing information outsourcing according to claim 1, further comprising, locating said first storage node to reduce risks to integrity of information stored at said first storage node and posed by a geographical location of at least a first of said plurality of enterprises.

27. A method for providing information outsourcing according to claim 1, further comprising, providing at least a first of said plurality of enterprises with multiple access points to said first storage node.

28. A method for providing information outsourcing according to claim 1, further comprising, providing an enterprise user interface for enabling at least a first of said plurality of enterprises to monitor selected operational parameters relating to said first enterprise's use of storage space at said first storage node.

29. A method for providing information outsourcing according to claim 28, wherein said enterprise user interface has an appearance that is independent of a technological implantation of said first storage node.

30. A method for providing information outsourcing according to claim 28, wherein said selected operational parameters include cost of storage space previously utilized by said first enterprise at said first storage node.

31. A method for providing information outsourcing according to claim 28, wherein said selected operational parameters include a price of storage space that is available to be utilized by said first enterprise at said first storage node.

32. A method for providing information outsourcing according to claim 1, further comprising, providing an enterprise user interface for enabling at least a first of said plurality of enterprises to purchase from said first storage node storage space that is available to be utilized by said first enterprise.

33. A method for providing information outsourcing according to claim 1, further comprising, providing an enterprise user interface for enabling at least a first of said plurality of enterprises to contract with said first storage node for a selected service level agreement

34. A method for providing information outsourcing according to claim 1, further comprising, providing a system user interface for monitoring operational parameters associated with providing said information outsourcing to at least a first of said plurality of enterprises.

35. A method for providing information outsourcing according to claim 1, further comprising,
providing a second storage node communicatively coupled to said first storage node,
enabling a first enterprise not included in said plurality of enterprises, and which is located remotely with respect to said second storage node to communicatively couple to said second storage node by way of a second communication channel having sufficient bandwidth to enable said second storage node to provide primary storage services to said first enterprise,
enabling said first enterprise to transfer information to said second storage node by way of said second communication channel, and storing said information transferred from said second enterprise at said second storage node.

36. A method for providing information outsourcing according to claim 35, further comprising, enabling said first enterprise and at least one enterprise of said plurality of enterprises to transfer information between each other by way of said first and second storage nodes.

37. A method for providing information outsourcing according to claim 35, further comprising, enabling said first storage node to provide information outsourcing for said second enterprise.

38. A method for providing information outsourcing according to claim 37, further comprising, mirroring selected information from said first storage node to said second storage node to generate a dynamic copy of said selected information at said second storage node.

39. A method for providing information outsourcing according to claim 1, further comprising, providing at least one classification of a service level agreement between at least a first of said plurality of enterprises and said first storage node, wherein said classification of said service level agreement is identified by at least one of a primary, a mirrored, a backup, a network storage service level agreement, and a data distribution service.

40. A method for providing information outsourcing according to claim 20, wherein said primary storage for said first enterprise is provided in accord with a primary storage service level agreement.

41. A method for providing information outsourcing according to claim 20, wherein said primary storage for said first enterprise is provided in accord with a network storage service level agreement

42. A method for providing information outsourcing according to claim 20, wherein said primary storage for said first enterprise is provided in accord with a mirrored storage service level agreement.

43. A method for providing information outsourcing according to claim 1, further comprising,
providing a second storage node communicatively coupled to said first storage node by way of a communication channel having sufficient performance characteristics to enable said second storage node to provide primary storage services to said plurality of enterprises, and
enabling transfer of said information from said first enterprise to said second storage node.

44. A method for providing information outsourcing according to claim 1, wherein said first storage node copies information transferred from at least a first of said plurality of enterprises to others of said plurality of enterprises.

45. A system for providing information storage outsourcing comprising, a first storage node adapted for enabling a plurality of enterprises that are located remotely with respect to said first storage node to communicatively couple to said first storage node by way of communication channels having sufficient bandwidth to enable said first storage node to provide primary storage services to said plurality of enterprises, and adapted for storing information transferred to and from said plurality of enterprises.

46. A system for providing information outsourcing according to claim 45, wherein said first storage node is further adapted for providing at least a first of said plurality of enterprises with on-line access to information stored at said first storage node.

47. A system for providing information outsourcing according to claim 45, wherein said first storage node is further adapted for enabling at least a first of said plurality of enterprises to copy selected information from said first enterprise to said first storage node to create a snapshot copy of said selected information, wherein said snapshot copy enables said first enterprise to recover said selected information from said first storage node.

48. A system for providing information outsourcing according to claim 47, wherein said first storage node is further adapted for providing said first enterprise with on-line access to said snapshot copy of said selected information.

49. A system for providing information outsourcing according to claim 45, wherein said first storage node is further adapted for enabling at least a first of said plurality of enterprises to copy selected information in substantially real-time to said first storage node to provide a substantially real-time backup copy of said selected information.

50. A system for providing information outsourcing according to claim 45, wherein said first storage node is further adapted for enabling at least a first of said plurality of enterprises to enter a request to reserve an amount of storage space at said first storage node.

51. A system for providing information outsourcing according to claim 50, wherein said first storage node is further adapted for enabling said first enterprise to enter a request to update said amount of reserved storage space at said first storage node.

52. A system for providing information outsourcing according to claim 50, wherein said first storage node is further adapted for reserving said amount of storage space in response to said request.

53. A system for providing information outsourcing according to claim 50, wherein said first storage node is further adapted for enabling said first enterprise to transiently expand an amount of utilized storage space at said first storage node beyond said reserved storage space, without updating said amount of reserved storage space.

54. A system for providing information outsourcing according to claim 45, wherein said first storage node is further adapted for enabling at least a first of said plurality of enterprises to monitor an amount of storage capacity utilized by said first enterprise at said first storage node.

55. A system for providing information outsourcing according to claim 45, wherein said first storage node is further adapted for enabling at least a first of said plurality of enterprises to query said first storage node as to a cost of reserving a particular amount of storage space at said first storage node.

56. A system for providing information outsourcing according to claim 45, wherein said first storage node is further adapted for
coupling to a communication network, and for enabling at least a first of said plurality of enterprises to communicate with said first storage node by way of said communication network.

57. A system for providing information outsourcing according to claim 56, wherein said communication network is the Internet.

58. A system for providing information outsourcing according to claim 56, wherein said first storage node is further adapted for enabling said first enterprise to reserve an amount of storage space at said first storage node by communicating a reservation over said communication network.

59. A system for providing information outsourcing according to claim 56, wherein said first storage node is further adapted for enabling said first enterprise to update said amount of reserved storage space by communicating an updated reservation over said communication network.

60. A system for providing information outsourcing according to claim 56, wherein said first storage node is further adapted for enabling said first enterprise to monitor an amount of storage capacity utilized by said first enterprise at said first storage node by communicating with said first storage node over said communication network.

61. A system for providing information outsourcing according to claim 56, wherein said first storage node is further adapted for enabling said first enterprise to query said first storage node over said communication network to obtain a cost estimate of reserving a particular amount of storage space at said first storage node.

62. A system for providing information outsourcing according to claim 45, wherein said first storage node is further adapted for providing a service level agreement between said first enterprise and said first storage node, wherein said service level agreement specifies at least in part a guaranteed availability of information stored by said first enterprise at said first storage node.

63. A system for providing information outsourcing according to claim 45, wherein said first storage node is further adapted for providing a service level agreement between said first enterprise and said first storage node, wherein said service level agreement specifies at least in part a guaranteed frequency of snapshot copying of information stored by said first enterprise at said first storage node.

64. A system for providing information outsourcing according to claim 45, wherein said first storage node is further adapted for providing at said first storage node primary storage for at least a first of said plurality of enterprises.

65. A system for providing information outsourcing according to claim 45, further comprising, enabling transfer of information between said first storage node and at least a first of said plurality of enterprises in a manner that is substantially transparent to application programs executing at said first enterprise.

66. A system for providing information outsourcing according to claim 45, wherein said first storage node is further adapted for providing said first storage node at a distance of at least about one hundred feet from at least a first of said plurality of enterprises.

67. A system for providing information outsourcing according to claim 45, wherein said first storage node is further adapted for mirroring selected information from at least a first of said plurality of enterprises at said first storage node to generate a dynamic copy of said selected information at said first storage node.

68. A system for providing information outsourcing according to claim 67, wherein said first storage node is further adapted for enabling said first enterprise to update said copy of said selected information in substantially real-time.

69. A system for providing information outsourcing according to claim 45, wherein said first storage node is further adapted for being located sufficiently remote from at least a first of said plurality of enterprises to provide an increased likelihood of said first storage node surviving destruction of said first enterprise.

70. A system for providing information outsourcing according to claim 45, wherein said first storage node is further adapted for being located to reduce risks to integrity of information stored at said first storage node and posed by a geographical location of at least a first of said plurality of enterprises.

71. A system for providing information outsourcing according to claim 45, wherein said first storage node is further adapted for providing at least a first of said plurality of enterprises with multiple access points to said first storage node.

72. A system for providing information outsourcing according to claim 45, wherein said first storage node is further adapted for providing an enterprise user interface for enabling at least a first of said plurality of enterprises to monitor selected operational parameters relating to said first enterprise's use of storage space at said first storage node.

73. A system for providing information outsourcing according to claim 72, wherein said enterprise user interface has an appearance that is independent of a technological implantation of said first storage node.

74. A system for providing information outsourcing according to claim 72, wherein said selected operational parameters include cost of storage space previously utilized by said first enterprise at said first storage node.

75. A system for providing information outsourcing according to claim 72, wherein said selected operational parameters include a price of storage space that is available to be utilized by said first enterprise at said first storage node.

76. A system for providing information outsourcing according to claim 45, wherein said first storage node is further adapted for providing an enterprise user interface for enabling at least a first of said plurality of enterprises to purchase from said first storage node storage space that is available to be utilized by said first enterprise.

77. A system for providing information outsourcing according to claim 45, wherein said first storage node is further adapted for providing an enterprise user interface for enabling at least a first of said plurality of enterprises to contract with said first storage node for a selected service level agreement.

78. A system for providing information outsourcing according to claim 45, wherein said first storage node is further adapted for providing a system user interface for monitoring operational parameters associated with providing said information outsourcing to at least a first of said plurality of enterprises.

79. A system for providing information outsourcing according to claim 45, further comprising,
a second storage node communicatively coupled to said first storage node, and adapted for
enabling a first enterprise, not included in said plurality of enterprises, to communicatively couple to said second storage node by way of a second communication channel having sufficient bandwidth to enable said second storage node to provide primary storage services to said first enterprise, and wherein,
enabling said first enterprise to transfer information to said second storage node by way of said second communication channel, and for storing said information transferred from said second enterprise.

80. A system for providing information outsourcing according to claim 79, wherein said first and second storage nodes are further adapted for enabling said first enterprise and at least one enterprise of said plurality of enterprises to transfer information between each other by way of said first and second storage nodes.

81. A system for providing information outsourcing according to claim 79, wherein said first storage node is further adapted for providing information outsourcing for said second enterprise.

82. A system for providing information outsourcing according to claim 81, wherein said first and second storage nodes are further adapted for mirroring selected information from said first storage node to said second storage node to generate a dynamic copy of said selected information at said second storage node.

83. A system for providing information outsourcing according to claim 45, wherein said first storage node is further adapted for providing at least one classification of a service level agreement between at least a first of said plurality of enterprises and said first storage node, wherein said classification of said service level agreement is identified by at least one of a primary, a mirrored, a backup, a network storage service level agreement, and a data distribution service.

84. A system for providing information outsourcing according to claim 45, wherein said first storage node is further adapted for providing said data outsourcing for said first enterprise in accord with a primary storage service level agreement.

85. A system for providing information outsourcing according to claim 45, wherein said first storage node is further adapted for providing said data outsourcing for said first enterprise in accord with a network storage service level agreement.

86. A system for providing information outsourcing according to claim 45, wherein said first storage node is further adapted for providing said data outsourcing for said first enterprise in accord with a mirrored storage service level agreement.

87. A system for providing information outsourcing according to claim 45, further comprising,
a second storage node communicatively coupled to said first storage node by way of a communication channel having sufficient performance characteristics to enable said second storage node to provide primary storage services to said plurality of enterprises, and
adapted for enabling said first enterprise to transfer said information to said second storage node.

88. A system for providing information outsourcing according to claim 87, wherein said first and said second storage nodes are further adapted for copying information transferred from at least a first of said plurality of enterprises to others of said plurality of enterprises.

89. A storage node adapted for providing information outsourcing services, said storage node comprising,
a communication interface adapted for communicatively coupling said storage node to a plurality of enterprises and for transferring information between said storage node and said enterprises, wherein said coupling provides sufficient performance characteristics to enable said storage node to provide primary storage services to said plurality of enterprises,
a data storage system, adapted for storing logical units of information and for storing information transferred from said plurality of enterprises,
a switching mechanism for directing said information transferred from said plurality of enterprises to particular ones of said logical divisions of said data storage system.

90. A storage node adapted for providing information outsourcing services according to claim 89, further comprising, a backup storage system for storing selected portions of said information transferred from said plurality of enterprises.

91. A storage node adapted for providing information outsourcing services according to claim 90, further comprising, a backup storage server for effectuating storage of said selected portions of said information transferred from said plurality of enterprises.

92. A storage node adapted for providing information outsourcing services according to claim 89, further comprising, a storage node manager adapted for controlling operation of said switching mechanism.

93. A storage node adapted for providing information outsourcing services according to claim 91, further comprising, an operations center agent, adapted for providing information regarding operation of at least one of, said switching mechanism, said data storage system, and said backup server, to a destination external to said storage node.

94. A system for providing data outsourcing services comprising,
a storage node adapted for providing information storage for a plurality of enterprises, and for coupling to said enterprises by way of communication channels having sufficient performance characteristics to enable said storage node to provide primary storage services to said enterprises, and
an operations center, located remotely with respect to said storage node, and adapted for communicatively coupling to said storage node and for enabling a system administrator to observe and control aspects of operation of said storage node.

95. A system for providing data outsourcing services according to claim 94, wherein said operations center further includes,
an operations center computer for controlling aspects of operation of said operations center,
a database adapted for storing information regarding said operation of said storage node, and a system user interface for enabling said system administrator to observe and effect operation of said storage node.

96. A system for providing data outsourcing services according to claim 94, wherein said operations center is further adapted for providing an enterprise user interface, accessible over a communication network and adapted for enabling a particular one of said plurality of enterprises to access storage usage data regarding information belonging to said particular one of said plurality of enterprises and stored at said storage node.

97. A system for providing data outsourcing services according to claim 94, wherein said storage usage data includes at least one of, an amount of storage space currently being used by said particular one of said plurality of enterprises, a peak amount of storage space used during a selected period of time by said particular one of said plurality of enterprises, a cost of said storage space currently being used by said particular one of said plurality of enterprises, a peak cost for said peak amount of storage space used by said particular one of said plurality of enterprises, an amount of storage space reserved by said particular one, and a current service level agreement for said particular one of said plurality of enterprises.

98. A system for providing data outsourcing services according to claim 94, wherein said enterprise user interface is further adapted for providing said storage usage data to said enterprises in a manner substantially independent from a particular technological implementation of said storage node.

99. A system for distributing information comprising, a plurality of storage nodes geographically disbursed, wherein
said plurality of storage nodes communicatively couple in such a manner that each of said plurality of storage nodes is communicatively coupled to multiple other storage nodes of said plurality of storage nodes, and wherein
said plurality of storage nodes are adapted for distributing information originating from a first subset of said plurality of storage nodes to a second subset of said plurality of storage nodes.
